(19) United States
(12) Patent Application Publication
(10) Pub. No.: US 2008/0187345 A1
(43) Pub. Date: Aug. 7, 2008

(54) Image history storage method, image history storage system, image history storage program, and recording medium

(75) Inventor: Toru Sorihashi, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/012,078

(22) Filed: Jan. 31, 2008

(30) Foreign Application Priority Data
Feb. 1, 2007 (JP) 2007-023407

(51) Int. Cl. G03G 15/00; G06K 9/00

(52) U.S. Cl. 399/83; 382/100

(57) ABSTRACT

In one embodiment of an image history storage system, an image history storage computer accesses an image forming apparatus based on image forming apparatus identification information, requests image data attribute information from the image forming apparatus, receives the attribute information from the image forming apparatus, judges, with filtering information, whether or not to request sending of the image data corresponding to the attribute information, and requests the image data for which the sending request is judged necessary from the image forming apparatus, receives the image data from the image forming apparatus, and accumulates and stores the received image data.

### CROSS-REFERENCE TO RELATED APPLICATION

This application claims priority under 35 U.S.C. §119(a) on Japanese Patent Application No. 2007-023407 filed in Japan on Feb. 1, 2007, the entire contents of which are herein incorporated by reference.

### BACKGROUND OF THE INVENTION

1. Field of Invention

The present invention relates to an image history storage method, an image history storage system, an image history storage program, and a recording medium in which image data that has been printed or the like with an image forming apparatus is accumulated and stored from the image forming apparatus via a network in an image history storage computer.

2. Related Art

As image forming apparatuses such as copy machines, facsimile machines, and printers, there are image forming apparatuses that accumulate image data that has been printed or sent/received in a memory of that apparatus, and thus are capable of confirming and managing image data that has been processed.

There are systems that do not accumulate and manage image data on the basis of a single image forming apparatus unit, but rather, centrally manage a plurality of image forming apparatuses using a computer such as a server on a network. For example, according to JP H10-154228A, at the same time as printing image data with an image forming apparatus, image data is sent from the image forming apparatus to a workstation via a network, it is possible to accumulate and store the image data in the workstation.

However, when accumulating and storing the image data processed with image forming apparatuses using one image history storage computer, various types of image data from the image forming apparatuses are accumulated and stored concentrated in one image history storage computer, so problems occur with respect to data management of the accumulated and stored image data.

For example, the image data processed with the image forming apparatus has attributes such as being image data used by different users, being image data with different classes of image formation (specifically, classes such as copy, facsimile, print, and the like), being image data with different image formats (specifically, such as TIFF (Tagged Image File Format) or PDF (Portable Document Format), or being image data that includes text data.

When this sort of image data having various attributes is managed according to the attributes with one image history storage computer, a large burden is placed on that image history storage computer, which is not preferable.

Also, image data that is accumulated and stored in one image history storage computer may include information with a high level of secrecy. In this case, if the restriction level (security level) is in a low state in the image history storage computer, it is possible that information with a high level of secrecy that may be included in the image data accumulated and stored in the computer will be divulged.

From this viewpoint, there are demands to distribute image data processed with image forming apparatuses to a plurality of image history storage computers on a network according to the attributes of the image data.

With respect to this point, in a configuration in which, as in above-described JP H10-154228A, at the same time as printing image data with an image forming apparatus, image data is sent from the image forming apparatus to an image history storage computer such as a workstation via a network, it is necessary for the image forming apparatus to access the image history storage computer.

For example, it is presumed that the image forming apparatus-side is provided with a function to register in advance attribute information such as a user, image formation class, or image format of the image data and addresses of image history storage computers corresponding to the image data, and is also provided with a function to judge the attributes of image data that has been processed and send the image data to the image history storage computer corresponding to those attributes.

Therefore, due to the control configuration of the image forming apparatus becoming more complicated, when a plurality of image forming apparatuses are present, it is necessary to register the addresses of image history storage computers for each of the plurality of image forming apparatuses on the network, and thus making settings for the system as a whole is very troublesome.

Also, there is a possibility that a plurality of image forming apparatuses will access an image history storage computer at the same time, and in such a circumstance, because the processing capability of the image history storage computer is inadequate, an image forming apparatus will enter a standby state, thus negatively affecting usability for the user.

### SUMMARY OF THE INVENTION

It is an object of the present invention to provide an image history storage method, an image history storage system, an image history storage program, and a recording medium in which, without a control structure of an image forming apparatus becoming complicated, it is possible to accumulate and store image data processed with that image forming apparatus by distributing that image data according to the attributes of the data to a plurality of image history storage computers on a network, and in which, without performing a troublesome address registration operation, it is possible to prevent a standby state of the image forming apparatus from occurring.

The present invention provides the following image history storage method and image history storage system.

(1) Image History Storage Method

The present invention provides an image history storage method that accumulates and stores image data to at least two image history storage computers among a plurality of computers connected via a network to one or a plurality of image forming apparatuses that accumulate the image data and attribute information related to that image data, the method including: a step of requesting identification information in which, using identification information for the one or the plurality of image forming apparatuses that exist on the network, the at least two image history storage computers access an image forming apparatus corresponding to the identification information via the network, and request the attribute information accumulated in the image forming apparatus from the image forming apparatus; a step of sending attribute information in which the attribute information accumulated in the image forming apparatus that responded to the request of the image history storage computer that requests the attribute information is sent from the image forming apparatus via the network to the image history storage computer; a step of filtering attribute information in which, using filtering information that exists on the network, which is filtering information for judging whether or not to request sending of the image data, in the image history storage computer that requests the attribute information, based on the attribute information from the image forming apparatus that responded to the request of the image history storage computer, and the filtering information, a judgment is performed of whether or not to make a request to the image forming apparatus to send image data corresponding to the attribute information; a step of requesting image data in which, when judged in the image history storage computer that requests the attribute information that it is necessary to request sending of image data corresponding to the attribute information from the image forming apparatus that responded to the request of the image history storage computer, the image history storage computer that judged that the sending request is necessary requests to the image forming apparatus, via the network, for image data corresponding to target attribute information that is the target for which the sending request was judged necessary among the attribute information accumulated in the image forming apparatus that responded to the request of the image history storage computer; a step of sending image data in which, from the image forming apparatus that responded to the request of the image history storage computer that requests image data corresponding to the target attribute information, image data that is accumulated in the image forming apparatus and corresponds to the target attribute information is sent to the image history storage computer via the network; and a step of accumulating and storing image data in which, in the image history storage computer that requests image data corresponding to the target attribute information, image data corresponding to the target attribute information from the image forming apparatus that responded to the request of the image history storage computer is received, and accumulated and stored.

(2) Image History Storage System

The present invention also provides an image history storage system that accumulates and stores image data to at least two image history storage computers among a plurality of computers connected via a network to one or a plurality of image forming apparatuses that accumulate the image data and attribute information related to that image data, in which: each of the at least two image history storage computers, using identification information for the one or the plurality of image forming apparatuses that exist on the network, accesses an image forming apparatus corresponding to the identification information via the network, and requests the attribute information accumulated in the image forming apparatus from the image forming apparatus; the attribute information accumulated in the image forming apparatus that responded to the request is sent from the image forming apparatus via the network to the image history storage computer; using filtering information that exists on the network, which is filtering information for judging whether or not to request sending of the image data, based on the attribute information from the image forming apparatus that responded to the request, and the filtering information, a judgment is performed of whether or not to make a request to the image forming apparatus to send image data corresponding to the attribute information; when judged that it is necessary to request sending of image data corresponding to the attribute information from the image forming apparatus that responded to the request, via the network, image data is requested from the image forming apparatus corresponding to target attribute information that is the target for which the sending request was judged necessary among the attribute information accumulated in the image forming apparatus that responded to the request; image data that is accumulated in the image forming apparatus and corresponds to the target attribute information is sent from the image forming apparatus that responded to the request to the image history storage computer via the network; and the image data corresponding to the target attribute information from the image forming apparatus that responded to the request is received, and accumulated and stored.

In the image history storage method and image history storage system according to the present invention, the at least two image history storage computers access an image forming apparatus corresponding to identification information for the one or the plurality of image forming apparatuses via the network, request the attribute information accumulated in the image forming apparatus from the image forming apparatus, and the attribute information is sent from the image forming apparatus that responded to the request by this access, via the network, to the image history storage computer.

Whether or not to request sending of image data corresponding to the attribute information from the image forming apparatus is judged based on the attribute information from the image forming apparatus that responded to the request and the filtering information.

At this time, when judged that it is necessary to request sending of image data corresponding to the attribute information from the image forming apparatus that responded to the request, image data corresponding to the target attribute information is requested from the image forming apparatus via the network by the image history storage computer that judged that the sending request is necessary, and image data corresponding to the target attribute information is sent from the image forming apparatus that responded to the request by this access, via the network, to the image history storage computer. The image data is received by the image history storage computer, and accumulated and stored.

That is, by access from the at least two image history storage computers to the image forming apparatus corresponding to the identification information, the image data accumulated in the image forming apparatus is transferred from the image forming apparatus into the image history storage computer that judged that the sending request is necessary according to the filtering information.

Thus, according to the image history storage method and the image history storage system of the present invention, it is not necessary to provide the image forming apparatus with a function to register an address of the image history storage computer in advance, and accordingly, it is possible, without a control structure of the image forming apparatus becoming complicated, to accumulate and store image data processed with that image forming apparatus by distributing that image data according to the attributes of the data to the at least two image history storage computers on the network.

Also, it is not necessary for the image forming apparatus to access the at least two image history storage computers, nor is it necessary to register an address of an image history storage computer in the image forming apparatus.

Also, in a case in which a plurality of the image forming apparatuses exist, it is possible to determine the order of accessing each image forming apparatus on the side of an individual image history storage computer, so even when a plurality of image forming apparatuses are centrally managed by an individual image history storage computer, data communications do not occur between an individual image history storage apparatus and a plurality of image forming apparatuses at the same time, an individual image history storage computer is not overloaded, and it is possible to prevent the occurrence of a standby state in an image forming apparatus.

An example case can be given in which the image history storage method of the present invention further includes a step of storing filtering information in which, in each of the at least two image history storage computers, the filtering information is stored and maintained; and in the step of filtering attribute information, filtering information that is stored and maintained in the image history storage computer that requests the attribute information is used as the filtering information.

In this case, it is preferable that the image history storage method of the present invention further includes a step of editing filtering information in which, in at least one of the at least two image history storage computers, the filtering information is edited; and a step of updating filtering information in which filtering information in all of the image history storage computers other than an image history storage computer in which the filtering information has been edited is updated via the network to the edited filtering information. By adopting such a configuration, it is possible to easily make additions or modifications to the filtering information, and it is also possible to omit the labor of an updating operation that updates the filtering information for each of the at least two image history storage computers.

An example case can be given in which the image history storage method of the present invention further includes a step of storing filtering information in which, in one settings management computer among the plurality of computers, the filtering information is stored and maintained; and a step of reading out filtering information in which, in each of the at least two image history storage computers, the filtering information stored and maintained in the one settings management computer is read out from the one settings management computer via the network; in which in the step of filtering attribute information, filtering information that has been read out from the one settings management computer is used as the filtering information. By adopting such a configuration, it is possible to store and maintain the filtering information in the one settings management computer. Accordingly, it is possible to omit the labor of a registration operation that registers the filtering information for each of the at least two image history storage computers.

In this case, it is preferable to further include a step of editing filtering information in which, in the one settings management computer, the filtering information is edited. By adopting such a configuration, it is possible to easily make additions or modifications to the filtering information.

When storing and maintaining the filtering information in the one settings management computer, it is preferable that one among the at least two image history storage computers serves also as the single settings management computer. By adopting such a configuration, it is possible to reduce the cost of providing a settings management computer separate from the image history storage computers.

An example case can be given in which the image history storage method of the present invention further includes a step of storing identification information in which, in each of the at least two image history storage computers, identification information for the one or the plurality of image forming apparatuses is stored and maintained; in which in the step of requesting identification information, identification information that is stored and maintained in the image history storage computer that requests the attribute information is used as the identification information.

In this case, it is preferable to further include a step of editing identification information in which, in at least one of the at least two image history storage computers, the identification information for the one or the plurality of image forming apparatuses is edited; and a step of updating identification information in which identification information in all of the image history storage computers other than an image history storage computer in which the identification information has been edited is updated via the network to the edited identification information. By adopting such a configuration, it is possible to easily make additions or modifications to the identification information, and it is also possible to omit the labor of an updating operation that updates the identification information for each of the at least two image history storage computers.

Also, an example case can be given that includes, when storing and maintaining the filtering information in the one settings management computer, a step of storing identification information in which, in the single settings management computer, the identification information for the one or the plurality of image forming apparatuses is stored and maintained; and a step of reading out identification information in which, in each of the at least two image history storage computers, the identification information for the one or the plurality of image forming apparatuses that is stored and maintained in the single settings management computer is read out from the single settings management computer via the network; in which in the step of requesting identification information, identification information that has been read out from the single settings management computer is used as the identification information. By adopting such a configuration, it is possible to store and maintain the identification information in the one settings management computer. Accordingly, it is possible to omit the labor of a registration operation that registers the identification information for each of the at least two image history storage computers.

In this case, it is preferable to further include a step of editing identification information in which, in the single settings management computer, the identification information for the one or the plurality of image forming apparatuses is edited. By adopting such a configuration, it is possible to easily, make additions or modifications to the identification information.

In the present invention, examples of the image forming apparatus can include a copy machine, a scanner apparatus, a facsimile apparatus, and a printer, or, a multifunction device or the like provided with a copy function, a scanner function, a facsimile function, and a printer function. Examples of the attribute information can include user information, image forming class information (such as copy, facsimile, or print), image data image format information (such as TIFF (Tagged Image File Format) or PDF (Portable Document Format)), text presence or absence information of text-attached image and no-text image for the image data, image data restriction level, or the like. Representative identification information can include address information for the image forming apparatus. Examples of the filtering information can include a user information list made up of user information, a group information list made up of user group information, image forming class information for the image forming apparatus, image format information for the image data, text presence or absence information of text-attached image or no-text image for the image data, restriction level information for the image data, or the like.

A text-attached image refers to image data that includes text data. Here, text data means text data obtained by performing optical character recognition (OCR) processing on image data that includes character information, thus converting the character information into character codes. Also, a no-text image refers to image data on which optical character recognition processing has not been performed and does not include text data, regardless of whether or not the image data includes character information.

Also, the restriction level refers to the restriction level of a scope of use by a user (for example, a scope of use such as viewing image data).

The following can be given as examples of specific aspects of the image history storage method according to the present invention.

(a) In one aspect, the at least two image history storage computers include one collected information image history storage computer and another other collected information image history storage computer; the filtering information includes a predetermined type of collected information; and in the step of filtering attribute information, when judged that the attribute information is collected information in the filtering information, the collected information image history storage computer that requests the attribute information requests sending of image data corresponding to the attribute information, and when judged that the attribute information is not collected information in the filtering information, the other collected information image history storage computer that requests the attribute information requests sending of image data corresponding to the attribute information.

(b) In one aspect, the at least two image history storage computers include a plurality of collected information image history storage computers whose collected information differs from each other; the filtering information includes a predetermined plurality of types of collected information that respectively correspond to the plurality of collected information image history storage computers; and in the step of filtering attribute information, when judged that the attribute information matches collected information in the filtering information corresponding to the collected information image history storage computer, the collected information image history storage computer that requests the attribute information requests sending of image data corresponding to the attribute information.

The following can be given as an example of more specific aspects of (a) above.

(a1) User Information

In one aspect, the at least two image history storage computers include one user image history storage computer and another other user image history storage computer; the attribute information includes user information for the image data; the collected information includes a user information list made up of the user information; and in the step of filtering attribute information, when user information in the attribute information exists in the user information list in the filtering information, the user image history storage computer that requests the attribute information requests sending of image data corresponding to the attribute information, and when user information in the attribute information does not exist in the user information list in the filtering information, the other user image history storage computer that requests the attribute information requests sending of image data corresponding to the attribute information.

The following can be given as examples of more specific aspects of (b) above.

(b1) User Group Information

In one aspect, the at least two image history storage computers include a plurality of user group image history storage computers whose user information groups differ from each other; the attribute information includes user group information for the image data; the filtering information includes a group information list made up of user group information that respectively corresponds to the plurality of user group image history storage computers; and in the step of filtering attribute information, when user group information in the attribute information matches user group information of the group information list in the filtering information corresponding to the user group image history storage computer, the user group image history storage computer that requests the attribute information requests sending of image data corresponding to the attribute information.

(b2) Image Forming Class Information

In one aspect, the at least two image history storage computers include a plurality of image forming class image history storage computers whose image forming classes of the image forming apparatus differ from each other; the attribute information includes image forming class information for the image forming apparatus; the filtering information includes image forming class information for the image forming apparatus that respectively corresponds to the plurality of image forming class image history storage computers; and in the step of filtering attribute information, when image forming class information in the attribute information matches image forming class information in the filtering information corresponding to the image forming class image history storage computer, the image forming class image history storage computer that requests the attribute information requests sending of image data corresponding to the attribute information.

(b3) Image Format Information of Image Data

In one aspect, the at least two image history storage computers include a plurality of image format image history storage computers whose image formats for the image data differ from each other; the attribute information includes image format information for the image data; the filtering information includes image format information for the image data that respectively corresponds to the plurality of image format image history storage computers; and in the step of filtering attribute information, when image format information in the attribute information matches image format information in the filtering information corresponding to the image format image history storage computer, the image format image history storage computer that requests the attribute information requests sending of image data corresponding to the attribute information.

(b4) Text Presence or Absence Information of Image Data

In one aspect, the at least two image history storage computers include one text-attached image history storage computer and another no-text image history storage computer; the attribute information includes text presence or absence information of text-attached image and no-text image for the image data; the filtering information includes text presence or absence information of text-attached image and no-text image for the image data that respectively corresponds to the text-attached image history storage computer and the no-text image history storage computer; and in the step of filtering attribute information, when the text presence or absence information in the attribute information is text-attached image information in the corresponding filtering information, the text-attached image history storage computer that requests the attribute information requests sending of image data corresponding to the attribute information, and when the text presence or absence information in the attribute information is no-text image information in the corresponding filtering information, the no-text image history storage computer that requests the attribute information requests sending of image data corresponding to the attribute information.

(b5) Restriction Level Information of Image Data

In one aspect, the at least two image history storage computers include a plurality of restriction image history storage computers whose restriction levels for the image data differ from each other; the attribute information includes restriction level information for the image data; the filtering information includes restriction level information for the image data that respectively corresponds to the plurality of restriction image history storage computers; and in the step of filtering attribute information, when restriction level information for the image data in the attribute information matches restriction level information for the image data in the filtering information corresponding to the restriction image history storage computer, the restriction image history storage computer that requests the attribute information requests sending of image data corresponding to the attribute information.

Further, as a specific aspect of above (b2), it is possible to give an example aspect in which the at least two image history storage computers include one copy image history storage computer, another facsimile image history storage computer, and another print image history storage computer; the attribute information includes copy, facsimile, and print class information; the filtering information is copy, facsimile, and print class information that respectively corresponds to the copy image history storage computer, the facsimile image history storage computer, and the print image history storage computer; and in the step of filtering attribute information, when image forming class information in the attribute information is copy class information in the corresponding filtering information, the copy image history storage computer that requests the attribute information requests sending of image data corresponding to the attribute information, and when image forming class information in the attribute information is facsimile class information in the corresponding filtering information, the facsimile image history storage computer that requests the attribute information requests sending of image data corresponding to the attribute information, and when image forming class information in the attribute information is print class information in the corresponding filtering information, the print image history storage computer that requests the attribute information requests sending of image data corresponding to the attribute information.

Further, as a specific aspect of above (b2), it is possible to give an example aspect in which the at least two image history storage computers include one TIFF image history storage computer and another PDF user image history storage computer; the attribute information includes TIFF and PDF image format information for the image data; the filtering information includes TIFF and PDF image format information for the image data that respectively corresponds to the TIFF image history storage computer and the PDF image history storage computer; and in the step of filtering attribute information, when the image format information for the image data in the attribute information is TIFF image format information in the corresponding filtering information, the TIFF image history storage computer that requests the attribute information requests sending of image data corresponding to the attribute information, and when the image format information for the image data in the attribute information is PDF image format information in the corresponding filtering information, the PDF image history storage computer that requests the attribute information requests sending of image data corresponding to the attribute information.

In the aspects of the image history storage method in above (a1) and (b1) to (b5), with respect to user information in above (a1), with respect to user group information in above (b1), with respect to image forming class information in above (b2), with respect to image format information for the image data in above (b3), with respect to text presence or absence information for the image data in above (b4), and with respect to restriction level information for the image data in above (b5), the image data can be stored in the image history storage computer corresponding thereto, so it is possible to realize practical implementation of information management according to the respective information.

In the image history storage method according to the present invention, it is preferable to further include a step of requesting image data deletion in which, after accumulating and storing image data corresponding to the target attribute information in the step of accumulating and storing image data, the image history storage computer that requests image data corresponding to the target attribute information requests, to the image forming apparatus that responded to the request of the image history storage computer, via the network, to delete the image data; and a step of deleting image data in which it is deleted the image data corresponding to the target attribute information that is accumulated in the image forming apparatus that responded to the request of the image history storage computer from the image history storage computer that requests deletion of the image data. Thus, it is possible to minimize the accumulation capacity for the image data in the image forming apparatus.

In this case, the image history storage method according to the present invention may further include a step of sending an image data deletion confirmation signal in which after the image data is deleted in the step of deleting image data, a confirmation signal notifying that the image data was deleted in the image forming apparatus that responded to the request is sent from the image forming apparatus via the network to the image history storage computer that requests deletion of the image data.

The image history storage method according to the present invention may further include a step of accumulating and storing attribute information in which, in the image history storage computer that requests the attribute information, the attribute information that has been sent from the image forming apparatus that responded to the request in the step of sending attribute information is accumulated and stored.

In this case, it is preferable to include a step of requesting attribute information deletion in which, after accumulating and storing image data corresponding to the target attribute information in the step of accumulating and storing image data, the image history storage computer that requests image data corresponding to the target attribute information requests, to the image forming apparatus that responded to the request of the image history storage computer, via the network, to delete the target attribute information, and a step of deleting attribute information in which the target attribute information that is accumulated in the image forming apparatus that responded to the request of the image history storage computer is deleted from the image history storage computer that requests deletion of target attribute information. Thus, it is possible to minimize the accumulation capacity of the attribute information in the image forming apparatus.

In this case, the image history storage method according to the present invention may further include a step of sending an attribute information deletion confirmation signal in which after the attribute information is deleted in the step of deleting attribute information, a confirmation signal notifying that the attribute information was deleted in the image forming apparatus that responded to the request is sent from the image forming apparatus via the network to the image history storage computer that requests deletion of the attribute information.

In the image history storage method according to the present invention, in the step of requesting identification information, it is preferable that the attribute information that is accumulated in the image forming apparatus corresponding to the identification information is requested from the image forming apparatus according to a time schedule, other than when network communications are concentrated. By adopting such a configuration, attribute information is not sent to the plurality of image history storage computers when network communications are concentrated. Accordingly, it is possible to make congestion of data communications unlikely, and thus it is possible to realize smooth data communications.

The present invention also provides the following image history storage program and recording medium.

(3) Image History Storage Program

The present invention provides an image history storage program for allowing a computer to execute each step of an image history storage method according to the present invention.

(4) Recording Medium

The present invention provides a computer-readable recording medium on which an image history storage program according to the invention is recorded.

It is possible to realize an image history storage system according to the present invention by allowing a plurality of computers, connected via a network to one or a plurality of image forming apparatuses that accumulate image data and attribute information related to the image data, to execute an image history storage program according to the present invention and an image history storage program that has been read from a recording medium according to the present invention.

As described above, according to the present invention, it is possible to provide an image history storage method, an image history storage system, an image history storage program, and a recording medium in which, without a control structure of an image forming apparatus becoming complicated, it is possible to accumulate and store image data processed with that image forming apparatus by distributing that image data according to the attributes of the data to a plurality of image history storage computers on a network, and in which, without performing a troublesome address registration operation, it is possible to prevent a standby state of the image forming apparatus from occurring.

### BRIEF DESCRIPTION OF THE DRAWINGS

FIG. 1 is a block diagram that shows an example of the basic configuration of an image history storage system of a first embodiment that implements an image history storage method according to the present invention.

FIG. 2 conceptually shows, in an image forming apparatus, an image storage area in a nonvolatile memory in which image data is accumulated.

FIG. 3 conceptually shows, in an image forming apparatus, an attribute information table in a nonvolatile memory in which attribute information is accumulated.

FIG. 4 conceptually shows, in an image history storage computer, an address table in a nonvolatile memory in which addresses of various image forming apparatuses have been accumulated.

FIG. 5 conceptually shows, in an image history storage computer, a filtering information table in which filtering information has been accumulated.

FIG. 6 conceptually shows, in an image history storage computer, an image storage area in a nonvolatile memory in which image data is accumulated.

FIG. 7 conceptually shows, in an image history storage computer, an attribute information table in a nonvolatile memory in which attribute information is accumulated.

FIG. 8 is a flowchart that shows an example process of the image history storage system according to the first embodiment.

FIG. 9 is a flowchart that shows only the process of steps S101 to S103 for printing, which are modified from the flowchart in FIG. 8.

FIG. 10 is a flowchart that shows only the process of steps S101 to S103 for scanning, which are modified from the flowchart in FIG. 8.

FIG. 11 is a flowchart that shows only the process of steps S101 to S103 for facsimile sending, which are modified from the flowchart in FIG. 8.

FIG. 12 is a flowchart that shows only the process of steps S101 to S103 for facsimile receiving, which are modified from the flowchart in FIG. 8.

FIG. 13 shows, in the first embodiment, an example configuration of an image history storage system that divides image data with one type of collected information among two image history storage computers.

FIG. 14 is a flowchart that shows an example process of the image history storage system shown in FIG. 13.

FIGS. 15(a) to 15(c) show a state in which image data is divided in the image history storage system shown in FIG. 13.

FIG. 16 is a flowchart that shows another example of the flowchart shown in FIG. 14.

FIG. 17 shows, in the first embodiment, an example configuration of an image history storage system that divides image data with a plurality of types of collected information among a plurality of image history storage computers corresponding to the types of collected information.

FIG. 18 shows, in the first embodiment, another example configuration of an image history storage system that divides image data with a plurality of types of collected information among a plurality of image history storage computers corresponding to the types of collected information.

FIG. 19 is a flowchart that shows an example process of the image history storage systems shown in FIGS. 17 and 18.

FIGS. 20(a) to 20(c) show a state in which image data is divided according to an example process in the image history storage system shown in FIG. 17.

FIGS. 21(a) to 21(c) show a state in which image data is divided according to another example process in the image history storage system shown in FIG. 17.

FIGS. 22(a) to 22(c) show a state in which image data is divided according to still another example process in the image history storage system shown in FIG. 18.

FIGS. 23(a) to 23(c) show a state in which image data is divided according to still another example process in the image history storage system shown in FIG. 18.

FIGS. 24(a) to 24(c) show a state in which image data is divided according to still another example process in the image history storage system shown in FIG. 17.

FIG. 25 is a block diagram that shows an example of the basic configuration of an image history storage system of a second embodiment that implements an image history storage method according to the present invention.

FIG. 26 is a flowchart that shows an example process of the image history storage system according to the second embodiment.

FIG. 27 is a flowchart that shows another example process of the image history storage system according to the second embodiment.

### DESCRIPTION OF THE PREFERRED EMBODIMENTS

Hereinafter, embodiments of the present invention will be described in detail with reference to the attached drawings.

<Basic Configuration of Image History Storage System of First Embodiment>

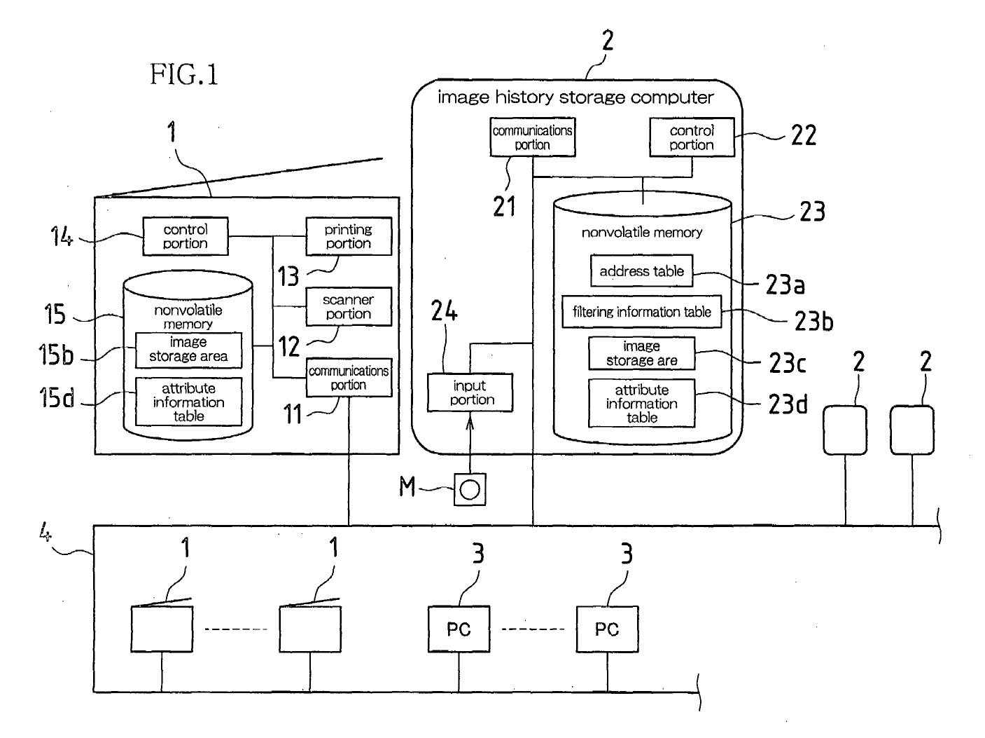

FIG. 1 is a block diagram that shows an example of the basic configuration of an image history storage system of a first embodiment that implements an image history storage method according to the present invention.

The image history storage system shown in FIG. 1 accumulates and stores image data that has been processed with image forming apparatuses 1 to at least two image history storage computers among a plurality of computers connected via a network 4 to one or a plurality of image forming apparatuses (here, a plurality of image forming apparatuses 1).

Specifically, in this image history storage system, a plurality of image forming apparatuses 1 (referred to hereinafter as simply an image forming apparatus 1), a plurality of image history storage computers 2 (referred to hereinafter as simply an image history storage computer 2), and a plurality of personal computers 3 (referred to hereinafter as simply a personal computer 3) are interconnected via an Ethernet (registered trademark) network 4, and thus a communications connection for data communications or the like between the image forming apparatus 1 and the personal computer 3, or between the image forming apparatus 1 and the image history storage computer 2 is possible.

The image forming apparatuses 1 are, for example, digital multifunction devices that fulfill the roles of a scanner, a copy machine, a facsimile apparatus, and a printer, and are provided with a scanner function to read an original image with a scanner; a copy function to read an original with a scanner, generate image data of the original image, and print this image data; a facsimile sending function to read an original image with a scanner and send image data of the original image via facsimile communications; a facsimile receiving function to receive image data via facsimile communications, and print this image data; and a printer function to receive image data from the personal computer 3 and print this image data.

Also, the image forming apparatuses 1 are provided with an accumulation means that accumulates image data that has been processed and attribute information related to that image data. The accumulation means includes a nonvolatile memory 15 such as a magnetic disk apparatus. The nonvolatile memory 15 has an image storage area 15b and an attribute information table 15d; image data is accumulated in the image storage area 15b and attribute information is accumulated in the attribute information table 15d.

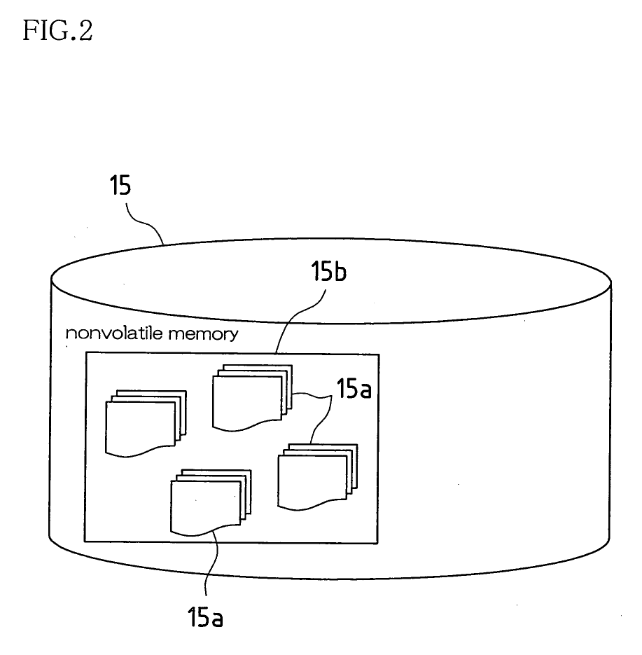

FIG. 2 conceptually shows, in the image forming apparatus 1, the image storage area 15b in the nonvolatile memory 15 in which image data 15a is accumulated. As shown in FIG. 2, a plurality of units of image data 15a are stored in the image storage area 15b.

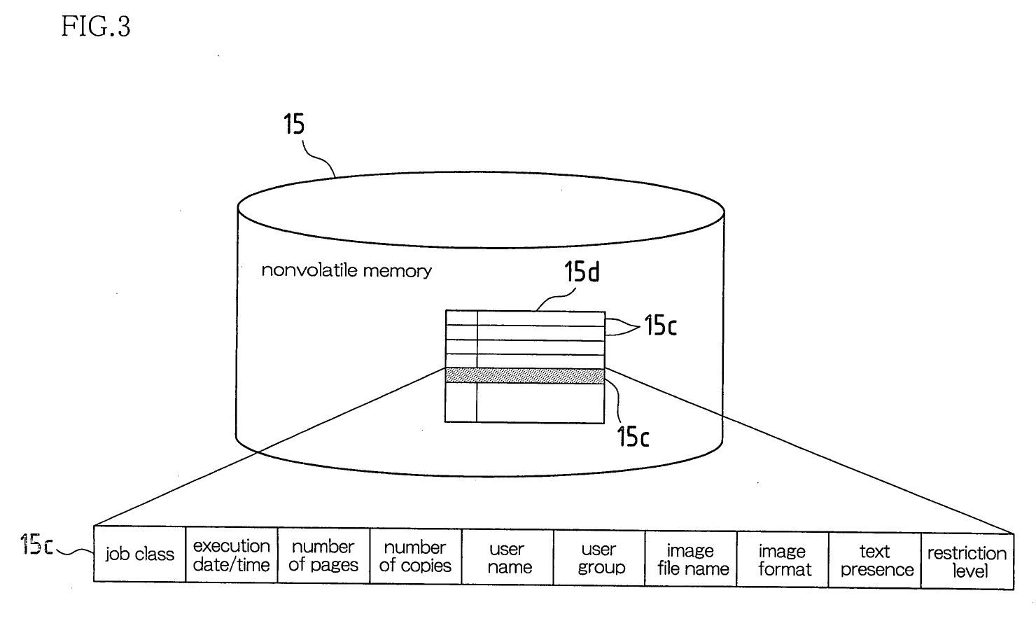

FIG. 3 conceptually shows, in the image forming apparatus 1, the attribute information table 15d in the nonvolatile memory 15 in which attribute information 15c is accumulated. As shown in FIG. 3, respective items of attribute information 15c corresponding to the plurality of units of image data 15a are accumulated, arranged in order, in the attribute information table 15d. The attribute information 15c includes, for example, process information of the image data 15a corresponding to the attribute information 15c (image forming class (job class) information such as copy, scan, print, or facsimile communications), information of the date and time of process execution, information of the number of pages of image data, information of the number of copies, user information such as a user name and user group, information of a file name of the image data, image format information of the image data such as TIFF or PDF, text presence or absence information of the image data indicating an image with text attached and an image without text, and restriction level information that indicates a level of secrecy for the image data.

The image forming apparatuses 1 are capable of creating image data and attribute information for that image data by creating image data attribute information whenever generating or receiving image data, such as when printing or facsimile communications are performed, and accumulating that image data and attribute information, and as described below, sending the image data and the attribute information for that image data to the image history storage computer 2 in response to access and a request from the image history storage computer 2.

As shown in FIG. 1, the image forming apparatus 1 is provided with, in addition to the nonvolatile memory 15, a communications portion 11, a scanner 12, a printing portion 13, and a control portion 14.

The communications portion 11 is connected to the network 4, and via the network 4, performs data communications between the image forming apparatus 1 and the image history storage computer 2, and between the image forming apparatus 1 and the personal computer 3. The scanner 12 reads an original image and outputs image data that expresses the original image. The printing portion 13 prints the image data on a recording material such as recording paper.

The control portion 14 performs overall control of the image forming apparatus 1, and is configured to control printing of image data, facsimile communications, data communications performed between the image forming apparatus 1 and the image history storage computer 2, and data communications performed between the image forming apparatus 1 and the personal computer 3.

On the other hand, the image history storage computer 2 fulfills the function of a server, i.e., the image history storage computer 2 stores identification information (here an address) for each image forming apparatus 1, accesses the image forming apparatuses 1 in order based on the identification information of the image forming apparatuses 1, requests the attribute information accumulated in the image forming apparatus 1 from the image forming apparatus 1, receives the attribute information from the image forming apparatus 1, judges whether or not to request sending of the image data corresponding to the attribute information, requests image data for which a sending request was judged necessary from the image forming apparatus 1, receives the image data from the image forming apparatus 1, and accumulates and stores that image data.

Also, the image history storage computer 2 is provided with an accumulation means that stores and maintains filtering information for performing a judgment of whether or not to request sending of the identification information and the image data of the image forming apparatus 1. This accumulation means includes a nonvolatile memory 23 such as a magnetic disk apparatus.

Specifically, as shown in FIG. 1, the image history storage computer 2 is provided with, in addition to the nonvolatile memory 23, a communications portion 21, a control portion 22, and an input portion 24.

The communications portion 21 is connected to the network 4, and via the network 4, performs data communications between the image forming apparatus 1 and the image history storage computer 2, and between the image history storage computer 2 and the personal computer 3. The input portion 24 is capable of reading out program information from a computer-readable recording medium M on which an image history storage program according to an embodiment of the invention has been recorded. The nonvolatile memory 23 is capable of storing program information that has been read out from the recording medium M, and in the nonvolatile memory 23, identification information for each image forming apparatus 1 is registered in an address table 23a, filtering information is registered in a filtering information table 23b, and image data and image data attribute information received from the image forming apparatus 1 is accumulated.

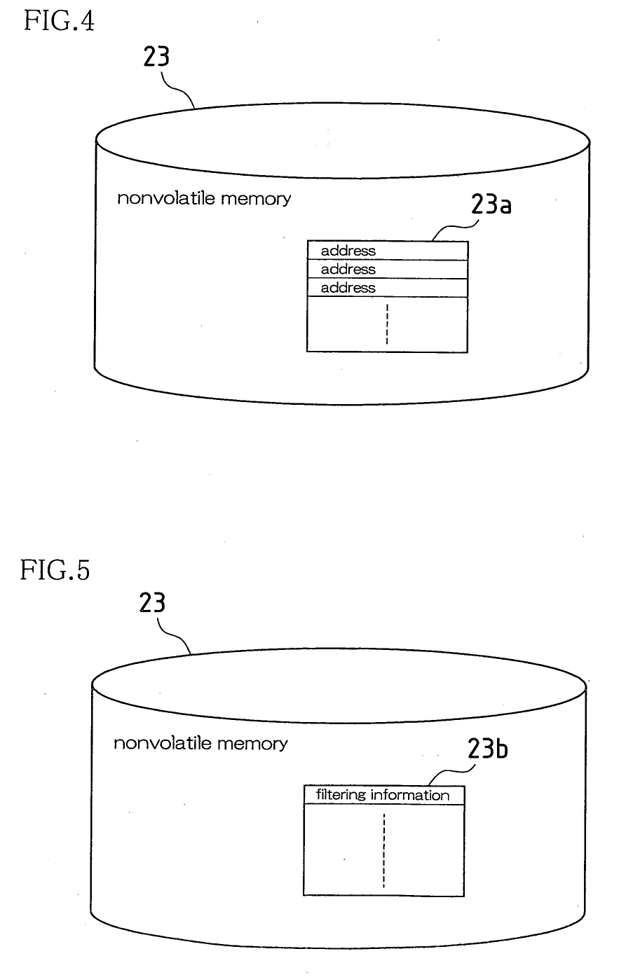

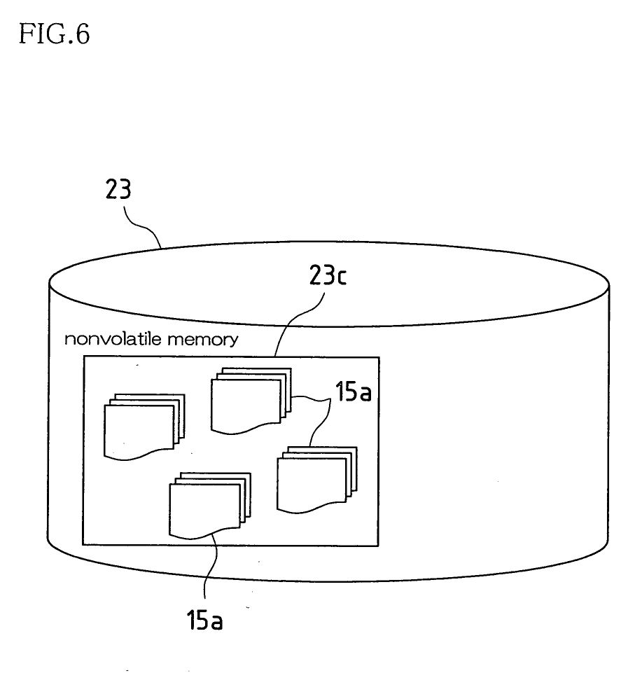

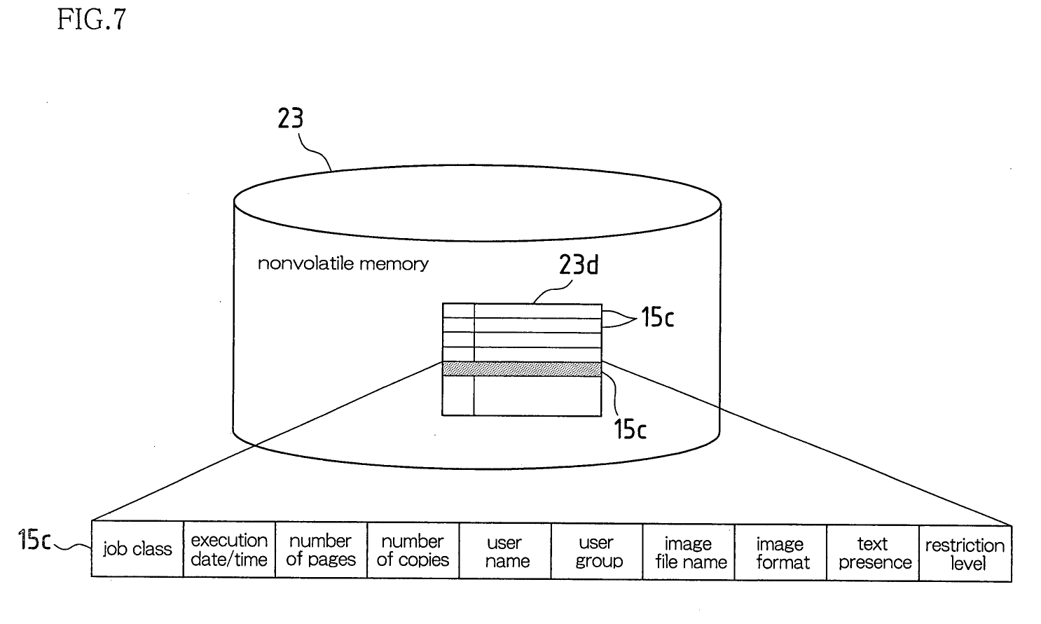

FIG. 4 conceptually shows, in the image history storage computer 2, the address table 23a in the nonvolatile memory 23 in which addresses for each image forming apparatus 1 have been accumulated, and FIG. 5 conceptually shows, in the image history storage computer 2, the filtering information table 23b in which filtering information has been accumulated. FIG. 6 conceptually shows, in the image history storage computer 2, an image storage area 23c in the nonvolatile memory 23 in which the image data 15a is accumulated, and FIG. 7 conceptually shows, in the image history storage computer 2, an attribute information table 23d in the nonvolatile memory 23 in which the attribute information 15c is accumulated.

The control portion 22 shown in FIG. 1 performs overall control of the image history storage computer 2 in which the control portion 22 is provided, and is provided with a CPU and a main storage portion that are not shown. The main storage portion is capable of reading an image history storage program that has been stored in the nonvolatile memory 23, and the CPU is capable of realizing an image history storage system according to first and second embodiments described below by executing the image history storage program that has been read by the main storage portion.

In the image history storage system described above, when the image forming apparatuses 1 have printed image data or performed facsimile communications, attribute information for the image data is created, and the image data and the attribute information for that image data are accumulated in the nonvolatile memory 15.

Also, the image history storage computer 2 reads out the identification information of the image forming apparatuses 1 from the nonvolatile memory 23, accesses each image forming apparatus 1 via the network 4 based on this identification information, and requests the attribute information for the image data from the image forming apparatuses 1. When the image forming apparatus 1 receives a request from the image history storage computer 2, the image forming apparatus 1 reads out the attribute information for the image data from the nonvolatile memory 15 in response to this request, and sends the attribute information for the image data to the image history storage computer 2 via the network 4. When the image history storage computer 2 receives the attribute information for the image data from the image forming apparatus 1, the image history storage computer 2 judges whether or not to request sending of the image data corresponding to the attribute information according to the filtering information, and when judged that a sending request is necessary, the image history storage computer 2 requests the image data from the image forming apparatus 1. When the image forming apparatus 1 receives a request from the image history storage computer 2, the image forming apparatus 1 reads out the image data from the nonvolatile memory 15 in response to this request, and sends the image data to the image history storage computer 2 via the network 4. When the image history storage computer 2 receives the image data from the image forming apparatus 1, the image history storage computer 2 accumulates and stores the image data in the nonvolatile memory 23.

Following is a more detailed description of the image history storage system according to the first embodiment with reference to the flowcharts in FIGS. 8 to 12.

FIG. 8 is a flowchart that shows an example process of the image history storage system according to the first embodiment. Note that FIG. 8 shows a state in which one image history storage computer 2 accesses one image forming apparatus 1, but it is possible to perform a similar process also when another image history storage computer 2 accesses the image forming apparatus 1. Also, the same process as that shown in FIG. 8 is performed when various image history storage computers 2 access a plurality of image forming apparatuses 1. Accordingly, a situation in which a plurality of image history storage computers 2 access a plurality of image forming apparatuses 1 is not shown.

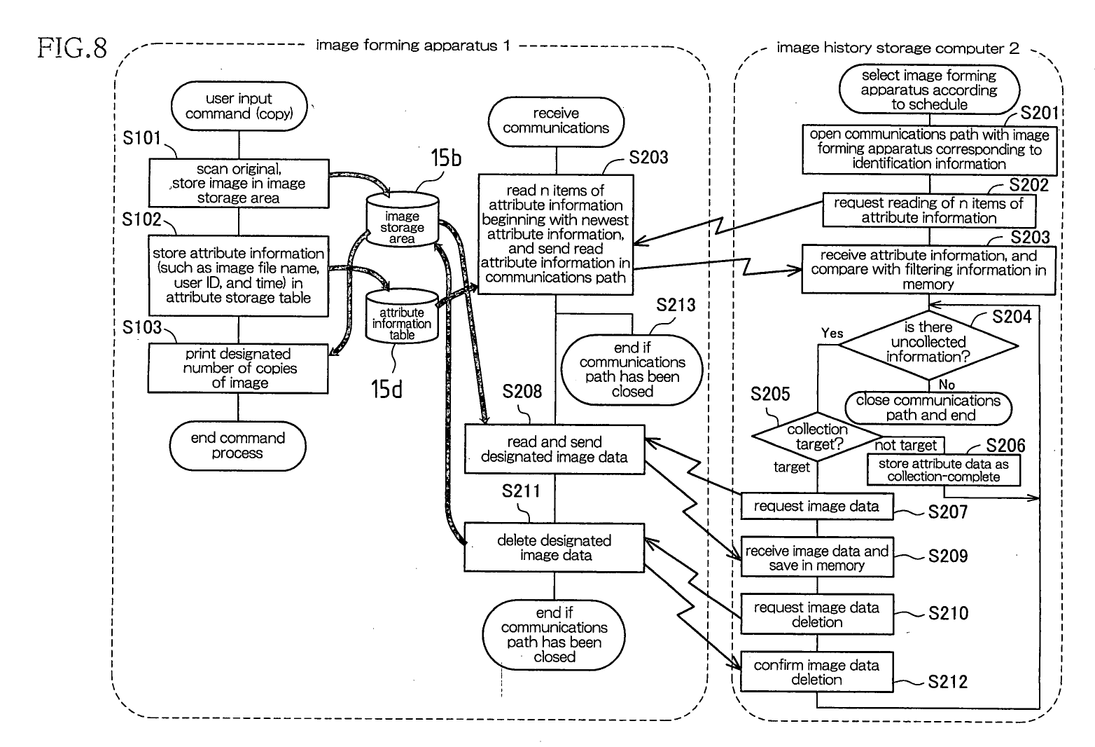

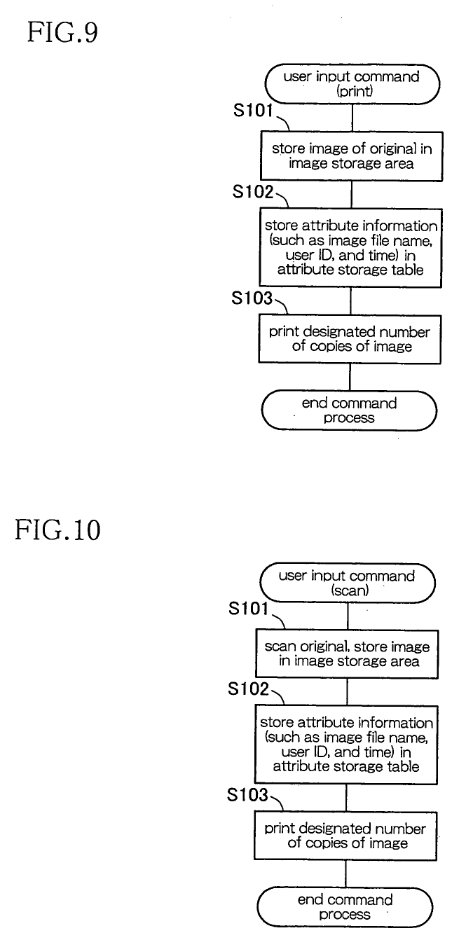

In the flowchart shown in FIG. 8, the image forming class of the image forming apparatus 1 is copy, and in the flowcharts for other classes of image forming, only the process of Steps S101 to S103 in the flowchart shown in FIG. 8 is modified. Accordingly, FIGS. 9 to 12 respectively show only the process of Steps S101 to S103 for printing, scanning, facsimile sending (fax sending), and facsimile receiving (fax receiving). Other processing is the same as shown in FIG. 8, and is therefore not shown.

In the image history storage system according to the first embodiment, whenever the image forming apparatus 1 generates or receives image data, image data attribute information is created, and the image data and the attribute information for that image data are accumulated in the nonvolatile memory 15 (Step S101).

For example, in the image forming apparatus 1, when copy and a number of copies to print and the like are designated by an input operation, image data of an original image is read by the scanner 12, and accumulated in the nonvolatile memory 15.

At this time, the control portion 14 creates attribute information for this image data, and this attribute information is stored in the attribute information table 15d in the nonvolatile memory 15 (Step S102). Then, when performing a printing operation, the control portion 14 starts up the printing portion 13, and designates to the printing portion 13 the number of printing copies of the image data. The printing portion 13 reads out the image data from the image storage area 15b in the nonvolatile memory 15, and prints the designated number of printing copies of the image data (Step S103).

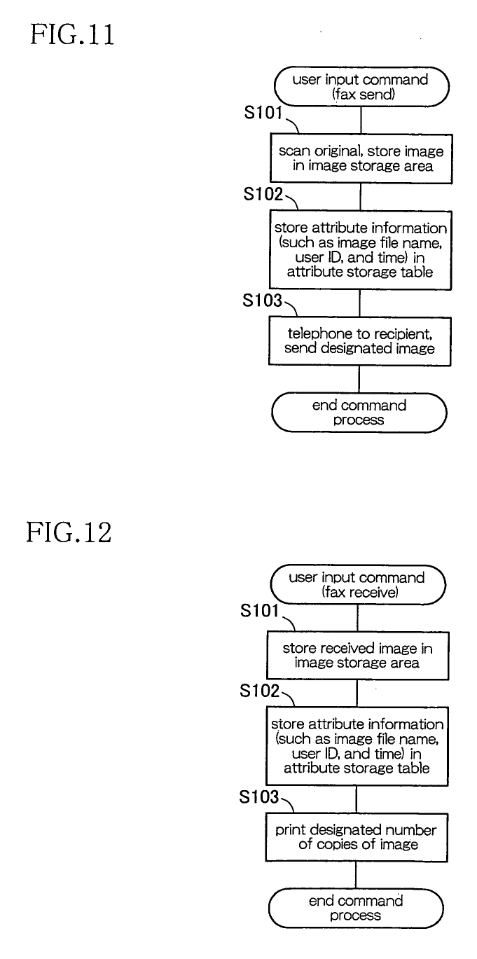

In the process shown in FIG. 8, in response to a print designation by an input operation in the image forming apparatus 1, image data of an original image is read and printed, attribute information for the image data is created at about the same time, and the image data and the attribute information are accumulated in the nonvolatile memory 15. However, when image data was received from the personal computer 3 and printed (see FIG. 9), or when in response to an input command received from the personal computer 3, an original image was read with the scanner 12 and the image data was printed (see FIG. 10), or when an original image was read with the scanner 12 and the image data was sent via facsimile communications (see FIG. 11), or when image data was received via facsimile communications and the image data was printed (see FIG. 12), attribute information for the image data is created, and the image data or the attribute information is accumulated in the nonvolatile memory 15.

In this manner, whenever image data is processed in the image forming apparatus 1, attribute information for the image data is created, and the image data and the attribute information are accumulated in the nonvolatile memory 15.

Image data and attribute information are continually accumulated as-is in the nonvolatile memory 15, and when there is a request from the image history storage computer 2 as described later, the image data and the attribute information are read out from the nonvolatile memory 15 and sent.

In each image history storage computer 2, according to the image history storage program, a step of storing identification information, a step of storing filtering information, a step of requesting identification information, a step of sending attribute information, a step of filtering attribute information, a step of requesting image data, a step of sending image data, and a step of accumulating and storing image data are executed.

That is, in the step of storing identification information, in the image history storage computer 2, identification information for the image forming apparatuses 1 is stored and maintained in the address table 23a of the nonvolatile memory 23 by a human operation performed by a user from an unshown operating portion. In the step of storing filtering information, in the image history storage computer 2, filtering information is stored and maintained in the filtering information table 23b of the nonvolatile memory 23 by a human operation performed by a user from an unshown operating portion. These processes are not shown in the flowchart in FIG. 8.

The control portion 22, periodically (cyclically) or according to a time schedule that has been set in advance (here according to a time schedule), using the identification information for the image forming apparatuses 1 that is stored and maintained in the image history storage computer 2, sequentially selects the image forming apparatus 1 corresponding to that identification information, and the communications portion 21 accesses the selected image forming apparatus 1 via the network 4. Then, if a communications path with the image forming apparatus 1 has been established (Step S201), the control portion 22 requests n items of attribute information from the image forming apparatus 1 (step of requesting identification information: Step S202).

In the image forming apparatus 1 that responded to the request, the request for n items of attribute information from the image history storage computer 2 that requests the attribute information is input to the control portion 14 via the communications portion 11. When inputting this request for n items of attribute information, the control portion 14 searches the attribute information table 15d in the nonvolatile memory 15, reads out n items of attribute information beginning from the newest item of attribute information, and sends these n items of attribute information from the image forming apparatus 1 to the image history storage computer 2 via the network 4 (step of sending attribute information: Step S203).

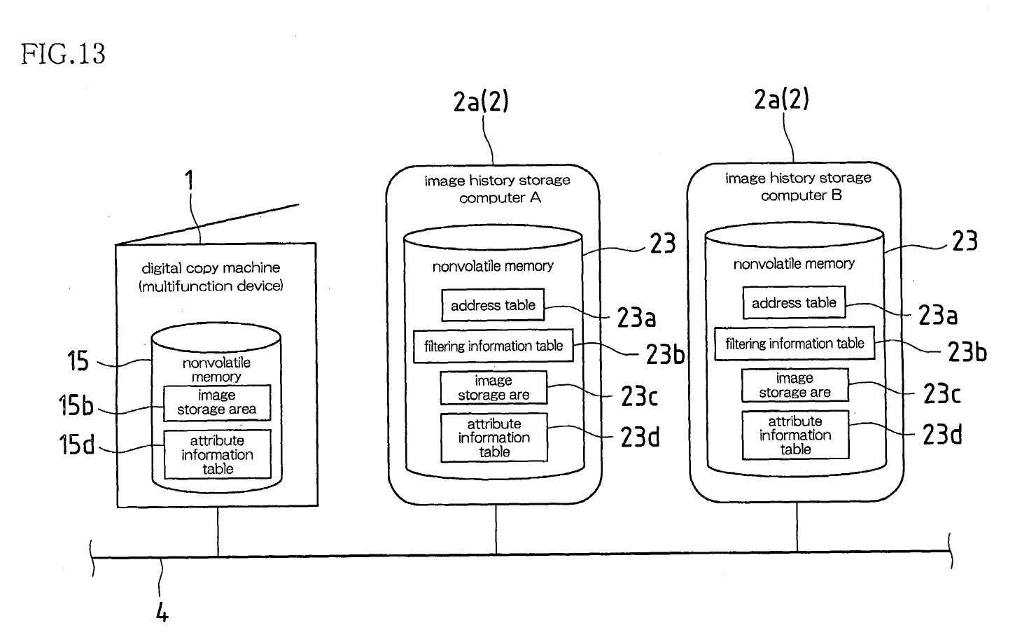

In the image history storage computer 2 that requests the attribute information, when inputting n items of attribute information via the communications portion 21, the control portion 22 compares the presently received n items of attribute information to n items of attribute information received in a prior instance from the same image forming apparatus 1 by previous access (S203), and when judged that the presently received n items of attribute information is not uncollected information (‘none’ in Step S204), the communications path is closed and the process ends. On the other hand, when the presently received n items of attribute information includes attribute information that does not match the previously received n items of attribute information (‘present’ in Step S204), the control portion 22 deems this attribute information that does not match to be uncollected new attribute information, and performs filtering on the new attribute information according to the filtering information that is stored and maintained in the image history storage computer 2 (step of filtering attribute information: Step S205). The filtering process performed using this filtering information will be described in detail below with reference to FIGS. 13 to 24(c).

In the first embodiment, a step of accumulating and storing attribute information is also executed in each image history storage computer 2.

That is, when new attribute information is not a collection target (‘non-target’ in Step S205), the attribute information is accumulated in the nonvolatile memory 23 (step of accumulating and storing attribute information: Step S206).

On the other hand, when the new attribute information is a collection target (‘target’ in Step S205), a request is made to the image forming apparatus 1 for image data corresponding to the target attribute information, which is the target for which it was judged that a sending request is necessary from among the attribute information accumulated in the image forming apparatus 1 that responded to the request via the network 4 (step of requesting image data: Step S207).

In the image forming apparatus 1 that responded to the request, when a request for image data corresponding to the target attribute information is input, the control portion 14 reads out the image data corresponding to the target attribute information from the image storage area 15b in the nonvolatile memory 15, and sends this image data to the image history storage computer 2 that requests the image data via the network 4 (step of sending image data: Step S208).

In the image history storage computer 2 that requests image data corresponding to the target attribute information, when the image data is input, the control portion 22 accumulates and stores this image data associated with the new attribute information in the nonvolatile memory 23 (step of accumulating and storing image data: Step S209).

In the first embodiment, a step of requesting image data deletion, a step of deleting image data, and a step of sending an image data deletion confirmation signal are further executed in each image history storage computer 2.

That is, in the image history storage computer 2 that requests image data corresponding to the target attribute information, when accumulation of the image data corresponding to the target attribute information finishes, the control portion 22 makes a request via the network 4 to the image forming apparatus 1 that responded to the request to delete the image data from the image history storage computer 2 (step of requesting image data deletion: Step S210).

In the image forming apparatus 1 that responded to the request, when the request to delete the image data corresponding to the target attribute information is received from the image history storage computer 2 that requests deletion of the image data, the control portion 14 deletes this image data from the image storage area 15b in the nonvolatile memory 15 (step of deleting image data: Step S211). Thus, empty storage capacity of the image storage area 15b in the nonvolatile memory 15 is always insured, allowing processes to continue without insufficient storage capacity. Then, the image history storage computer 2 that requests deletion of the image data is notified that image data deletion is complete (step of sending image data deletion confirmation signal: Step S212).

In the image history storage computer 2, when notification that image deletion is complete is received (Step S212), the process returns to Step S204, and when attribute information that does not match the previously received n items of attribute information remains in the presently received n items of attribute information (‘present’ in Step S204), the control portion 22 repeats the process in Steps S205 to S212 in order to collect and accumulate in the nonvolatile memory 23 the image data corresponding to this uncollected new information that does not match.

That is, when uncollected new attribute information remains (‘present’ in Step S204), and in Step S205 attribute information is the collection target (‘target’ in Step S205), in the image forming apparatus 1, the control portion 14 executes the process of Steps S208 and S211, reads out image data corresponding to the target attribute information from the nonvolatile memory 15 and sends that image data to the image history storage computer 2, and afterward deletes the image data from the nonvolatile memory 15.

When there is no more uncollected new attribute information (‘none’ in Step S204), the communications path between the communications portion 21 of the image history storage computer 2 and the communications portion 11 of the image forming apparatus 1 is closed.

In the image history storage system of the first embodiment, this series of processing is performed for each image history storage computer 2, and image data and attribute information deemed to be a collection target according to the filtering information is accumulated and stored in each image history storage computer 2.

Incidentally, attribute information ordinarily can be stored within a small capacity compared to image data. Therefore, in the first embodiment, in the image forming apparatus 1, the attribute information table of the nonvolatile memory 15 is insured to have an adequately large capacity (for example, a capacity of about 100,000 items), and can by cyclically saved (rewriting when capacity becomes full, in order from the oldest attribute information). However, the invention is not limited thereto; a configuration may also be adopted in which in each of the image history storage computers 2, after accumulating and storing image data corresponding to target attribute information in Step S209 of accumulating and storing image data, a step of requesting attribute information deletion is executed in which a request is made from the image history storage computer 2 that requests image data corresponding to the target attribute information via the network 4 to the image forming apparatus 1 that responded to the request to delete the target attribute information, and a step of deleting attribute information is executed in which the target attribute information accumulated is deleted in the image forming apparatus 1 that responded to the request from the image history storage computer 2 that requests deletion of the target attribute information.

In this manner, in the image history storage system of the first embodiment, by access from the image history storage computer 2 to the image forming apparatus 1 corresponding to the identification information, the image data accumulated in the image forming apparatus 1 is transferred from the image forming apparatus 1 into the image history storage computer 2 according to the filtering information.

Therefore, according to the image history storage system of the first embodiment, it is not necessary to provide the image forming apparatus 1 with a function to register addresses of the image history storage computers 2 in advance, and accordingly, it is possible, without providing the image forming apparatus 1 with a configuration for dividing image data among the image history storage computers 2, to accumulate and store image data processed in the image forming apparatus 1, with that image data divided according to the attributes of the image data among the image history storage computers 2 on the network 4.

Also, it not necessary for the image forming apparatus 1 to access the image history storage computer 2, nor is it necessary to register an address for the image history storage computer 2 in the image forming apparatus 1.

Also, when a plurality of image forming apparatuses 1 are present as in the first embodiment, it is possible to determine the order of accessing each image forming apparatus 1 on the side of an individual image history storage computer 2, so even when a plurality of image forming apparatuses 1 are centrally managed by an individual image history storage computer 2, data communications do not occur between an individual image history storage computer 2 and a plurality of image forming apparatuses 1 at the same time, an individual image history storage computer 2 is not overloaded, and it is possible to prevent the occurrence of a standby state in an image forming apparatus 1.

Further, in Step S202 of requesting identification information, when requesting attribute information from the image forming apparatuses 1, here, according to a time schedule, the attribute information is requested other than when network 4 communications are concentrated. By adopting such a configuration, attribute information is not sent to the image history storage computer 2 when network 4 communications are concentrated. Accordingly, it is possible to make congestion of data communications unlikely, and thus it is possible to realize smooth data communications.

Next is a description of a specific example of dividing image data among two image history storage computers 2 with one type of collected information, with reference to FIGS. 13 to 15(c).

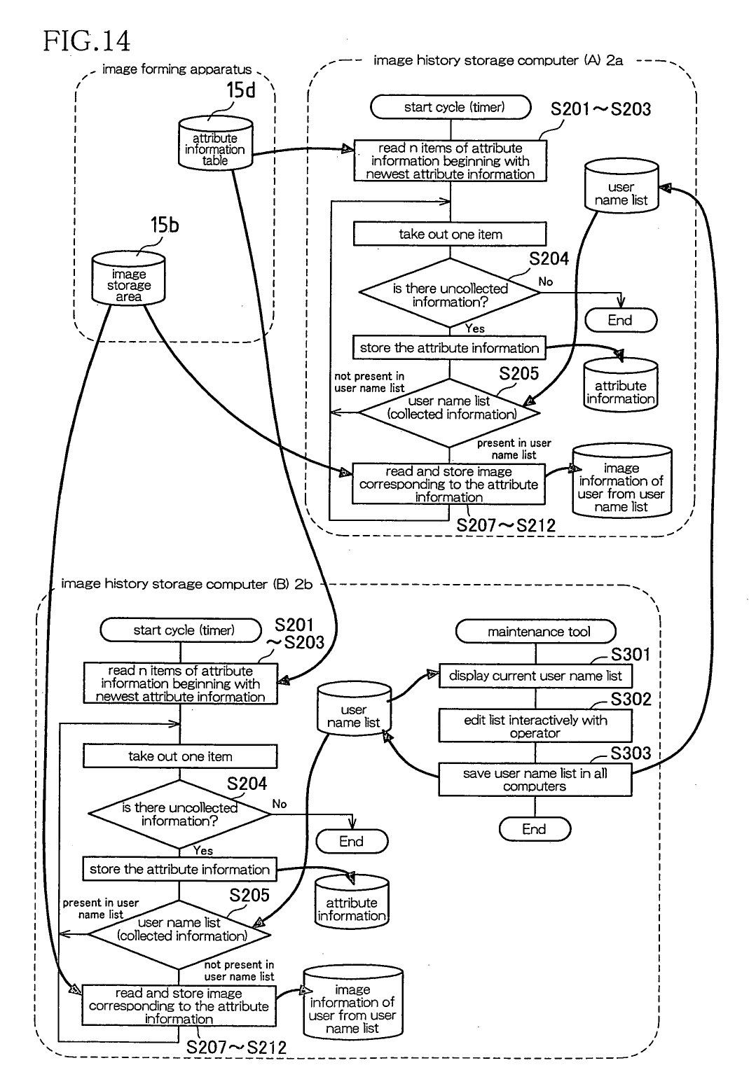

FIG. 13 shows, in the first embodiment, an example configuration of an image history storage system that divides image data with one type of collected information among two image history storage computers. FIG. 14 is a flowchart that shows an example process of the image history storage system shown in FIG. 13.

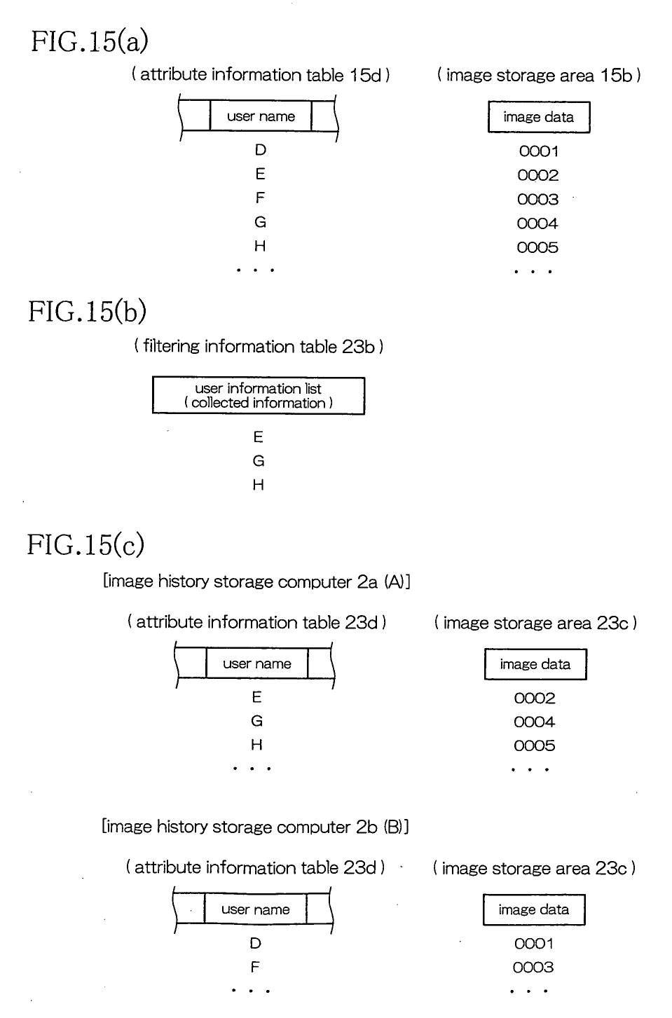

FIGS. 15(a) to 15(c) show a state in which image data is divided in the image history storage system shown in FIG. 13. FIG. 15(a) shows specific data of the attribute information table 15d and the image storage area 15b of the nonvolatile memory 15 in the image forming apparatus 1. FIG. 15(b) shows specific data of the filtering information table 23b of the nonvolatile memory 23 in the image history storage computer 2. FIG. 15(c) shows specific data of the attribute information table 23d and the image storage area 23c of the nonvolatile memory 23 in the image history storage computer 2.

In the flowchart shown in FIG. 14, the process is basically the same as the process according to a time schedule in the flowchart shown in FIG. 8, except for the point at which a cyclical process is performed by a timer, and FIG. 14 focuses on Step S205 of filtering attribute information. Accordingly, the same step numbers are assigned to substantially the same step locations, and the description below focuses on Step S205 of filtering attribute information. Also, in the flowchart shown in FIG. 14, two image history storage computers (A)2a and (B)2b are shown.

In this image history storage system, as shown in FIG. 13, the image history storage computers 2 include one collected information image history storage computer (A)2a and another other collected information image history storage computer (B)2b. Also, as shown in FIG. 15(b), the filtering information includes a predetermined type of collected information (user information in the example shown).

As shown in FIG. 14, in Step S205 of filtering attribute information, when judged that attribute information is collected information in the filtering information, the collected information image history storage computer (A)2a that requests attribute information requests sending of image data corresponding to the attribute information. When judged that attribute information is not collected information in the filtering information, the other collected information image history storage computer (B)2b that requests attribute information requests sending of image data corresponding to the attribute information. By adopting such a configuration, image data in the image forming apparatuses 1 can be distributed without omission among the image history storage computers (A)2a and (B)2b and accumulated and stored there. This is specifically described below, taking as an example a case in which the collected information in the filtering information is a user information list.

(User Information)

As shown in FIG. 13, the image history storage computers 2 include one user image history storage computer (A)2a and another other user image history storage computer (B)2b. Also, as shown in FIG. 15(a), the attribute information includes user information for image data (here a user name), and as shown in FIG. 15(b), the collected information includes a user information list made up of user information.

As shown in FIG. 14, in Step S205 of filtering attribute information, when user information in the attribute information (see FIG. 15(a)) exists in the user information list in the filtering information (see FIG. 15(b)), the user image history storage computer (A)2a that requests attribute information requests sending of image data corresponding to the attribute information. When user information in the attribute information (see FIG. 15(a)) does not exist in the user information list in the filtering information (see FIG. 15(b)), the other user image history storage computer (B)2b that requests attribute information requests sending of image data corresponding to the attribute information. Thus, it is possible that image data of a user that exists in the user information list is accumulated and stored in the user image history storage computer (A)2a, and image data of a user that does not exist in the user information list is accumulated and stored in the other user image history storage computer (B)2b (see FIG. 15(c)).

Note that the collected information in the filtering information may also be class information for facsimile communications.

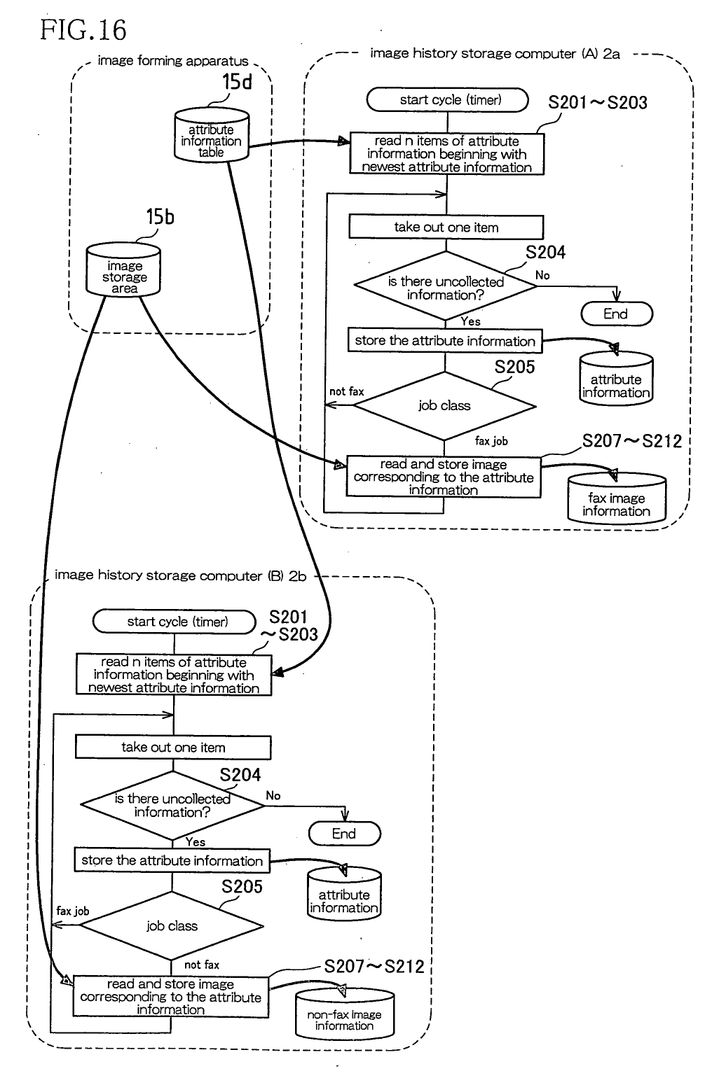

That is, a configuration may also be adopted in which, as shown in FIG. 16, the image history storage computers 2 include one facsimile image history storage computer (A)2a and another non-facsimile image history storage computer (B)2b, the attribute information includes class information that includes facsimile communications for the image data, the collected information includes class information of facsimile communications, and in Step S205 of filtering attribute information, when judged that the job class in the attribute information is facsimile communications in the filtering information, the facsimile image history storage computer (A)2a that requests attribute information requests sending of image data corresponding to the attribute information, and when judged that the job class in the attribute information is not facsimile communications in the filtering information, the non-facsimile image history storage computer (B)2b that requests attribute information requests sending of image data corresponding to the attribute information.

By adopting such a configuration, when managing the history of operation in the image forming apparatuses 1, a practical implementation is possible in which, for example, the operation history related to facsimile communications is managed by a department that handles mail and the like, and the operation history of other than facsimile communications, such as printing, scanning, and copying, is managed by another, general affairs department, and thus it is possible to physically divide servers, with each department performing management and maintenance.

Next is a description of a specific example of a process of dividing image data with a plurality of types of collected information among a plurality of image history storage computers corresponding to the types of collected information, with reference to FIGS. 17 to 24(c).

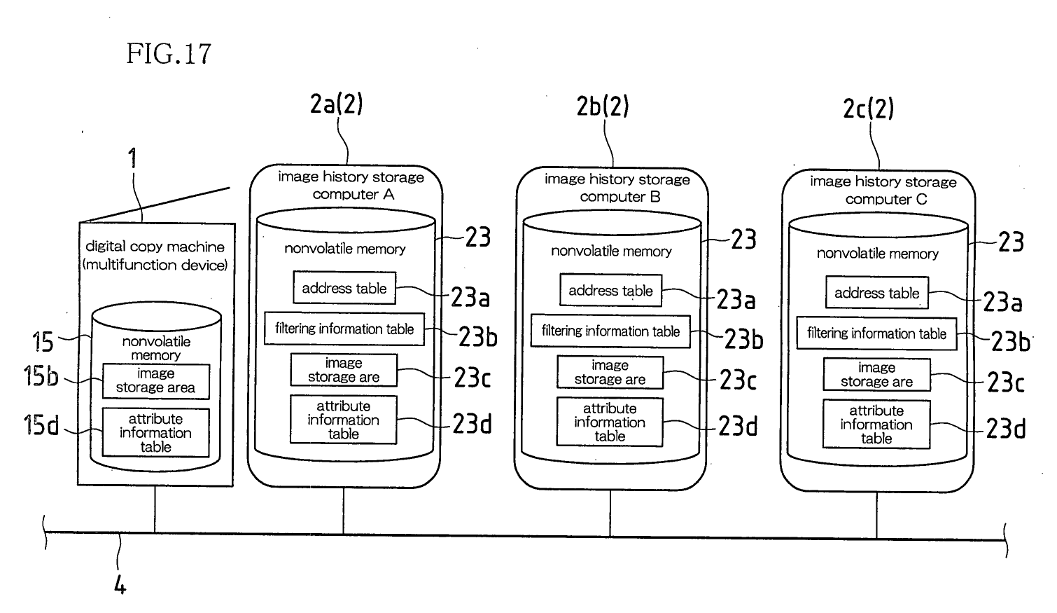

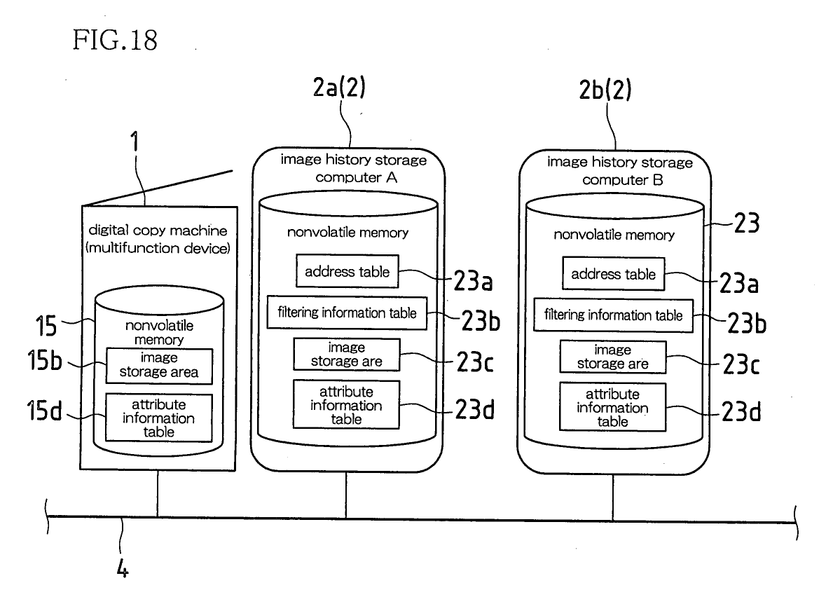

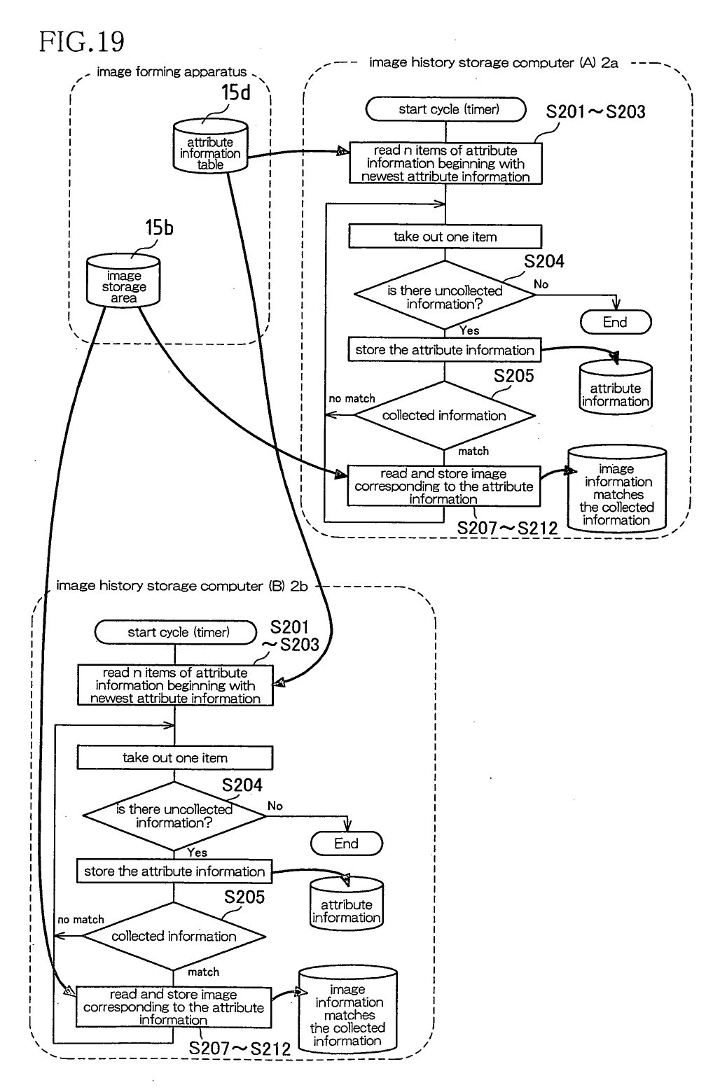

FIGS. 17 and 18 show, in the first embodiment, example configurations of an image history storage system that divides image data with a plurality of types of collected information among a plurality of image history storage computers corresponding to the types of collected information. FIG. 19 is a flowchart that shows an example process of the image history storage systems shown in FIGS. 17 and 18.

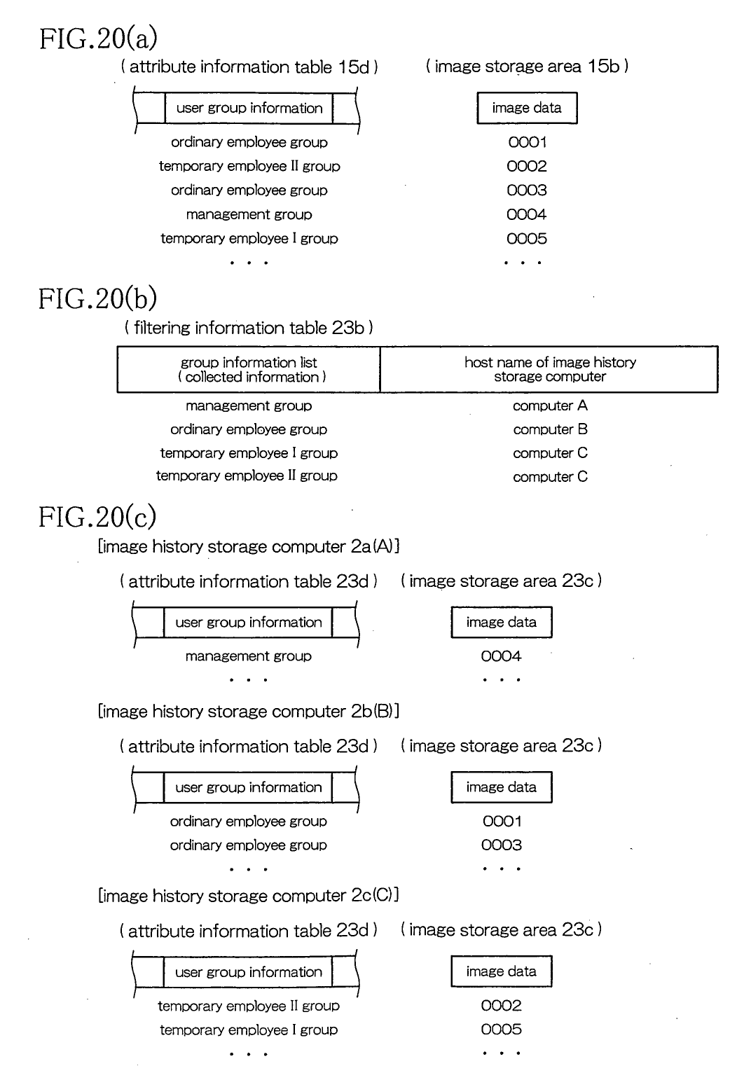

FIGS. 20(a) to 24(c) show a state in which image data is divided according to each example process in the image history storage system shown in FIGS. 17 and 18. FIGS. 20(a), 21(a), 22(a), 23(a), and 24(a) show specific data of the attribute information table 15d and the image storage area 15b of the nonvolatile memory 15 in the image forming apparatus 1. FIGS. 20(b ), 21(b), 22(b), 23(b), and 24(b) show specific data of the filtering information table 23b of the nonvolatile memory 23 in the image history storage computer 2. FIGS. 20(c), 21(c), 22(c), 23(c), and 24(c) show specific data of the attribute information table 23d and the image storage area 23c of the nonvolatile memory 23 in the image history storage computer 2.

In the flowchart shown in FIG. 19, the process is basically the same as the process according to a time schedule in the flowchart shown in FIG. 8, except for the point at which a periodic process is performed according to a timer, and FIG. 19 focuses on Step S205 of filtering attribute information. Accordingly, the same step numbers are assigned to substantially the same step locations, and the description below focuses on Step S205 of filtering attribute information. Also, in the flowchart shown in FIG. 19, two image history storage computers (A)2a and (B)2b are shown.

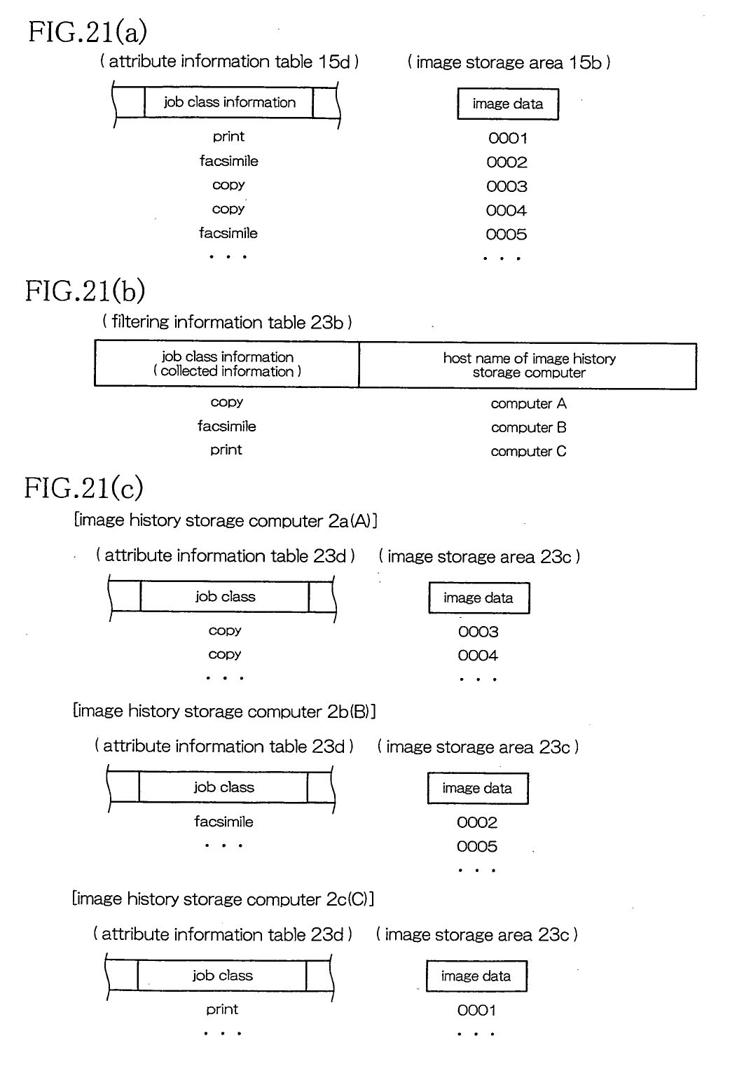

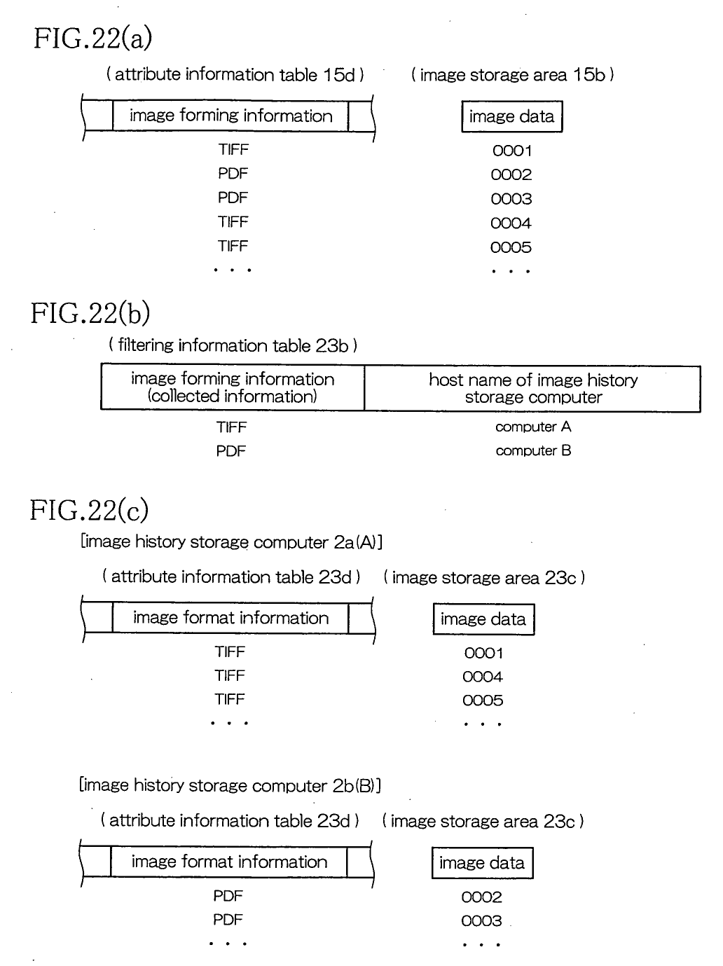

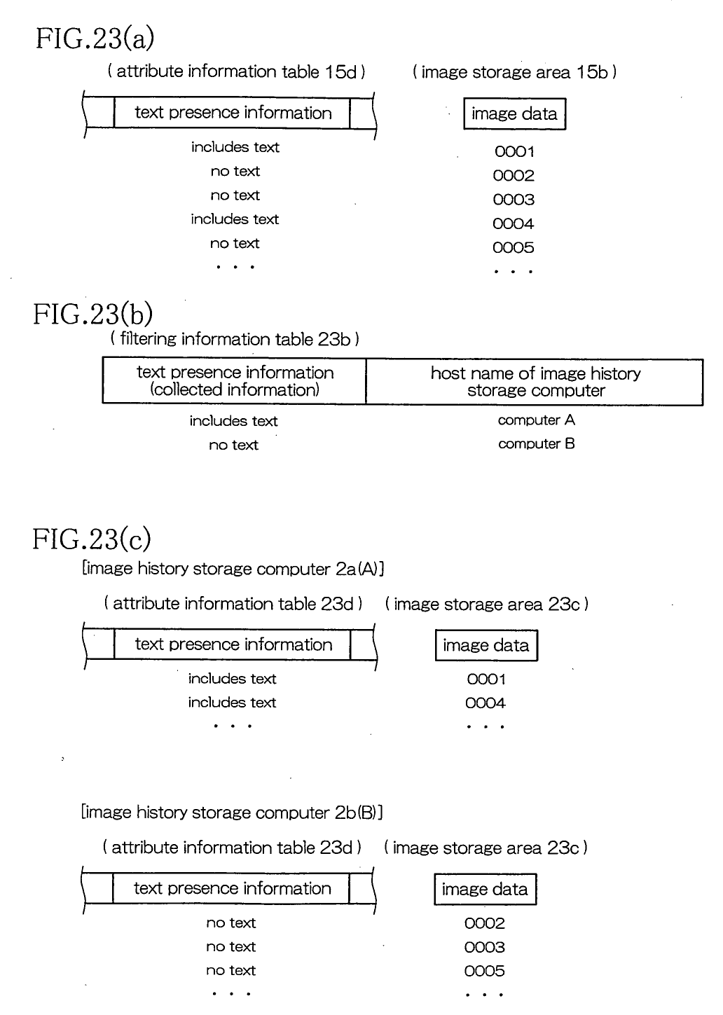

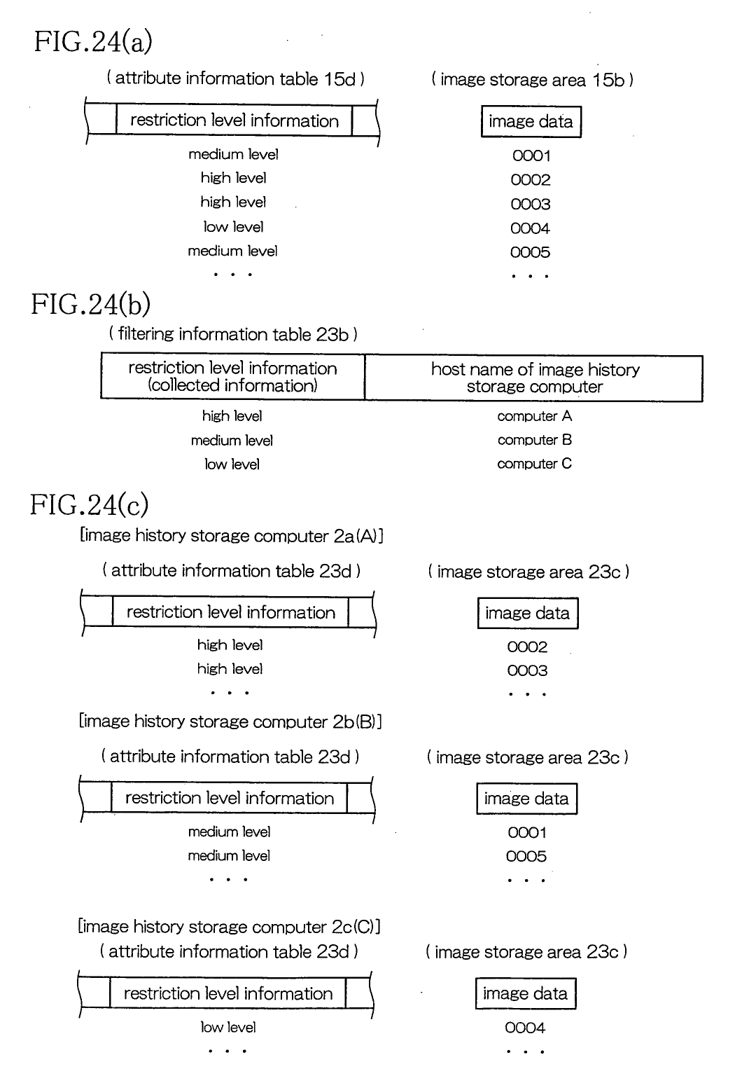

In this image history storage system, as shown in FIGS. 17 and 18, the image history storage computers 2 include a plurality of collected information image history storage computers (A)2a, (B)2b, etc. whose collected information differs from each other. Also, as shown in FIGS. 20(b), 21(b), 22(b), 23(b), and 24(b), the filtering information includes a predetermined plurality of types of collected information corresponding respectively to the plurality of collected information image history storage computers (A)2a, (B)2b, etc. (user group information in FIG. 20(b ), image forming class (job class) information in FIG. 21(b)), image data image format information in FIG. 22(b), image data text presence or absence information in FIG. 23(b), and image data restriction level information in FIG. 24(b)).

As shown in FIG. 19, in Step S205 of filtering attribute information, when judged that attribute information matches collected information in the corresponding filtering information, the collected information image history storage computers (A)2a, (B)2b, etc. that request attribute information request sending of image data corresponding to the attribute information to those image history storage computers. By adopting such a configuration, image data in the image forming apparatuses 1 can be accumulated and stored respectively divided among the image history storage computers (A)2a, (B)2b, etc. This is specifically described below, taking as an example a case in which the collected information in the filtering information is respectively, user group information, image forming class information, image data image format information, image data text presence or absence information, and image data restriction level information.

(User Group Information)

As shown in FIG. 17, the image history storage computers 2 include a plurality of user group image history storage computers whose user information groups differ from each other (for example, a management group image history storage computer (A)2a, an ordinary employee image history storage computer (B)2b, and a temporary employee image history storage computer (C)2c). Also, as shown in FIG. 20(a), the attribute information includes user group information (for example, management group, ordinary employee group, temporary employee groups I and II) for the image data, and as shown in FIG. 20(b ), the collected information includes a group information list made up of user group information (for example, management group, ordinary employee group, temporary employee group) corresponding respectively to the plurality of user group image history storage computers (A)2a, (B)2b, and (C)2c.

As shown in FIG. 19, in Step S205 of filtering attribute information, when the user group information in the attribute information (see FIG. 20(a)) matches user group information in the group information list in the corresponding filtering information (see FIG. 20(b )), the user group image history storage computers (A)2a, (B)2b, and (C)2c (computer (C)2c not shown in FIG. 19) that request attribute information request sending of image data corresponding to the attribute information. Thus, for example, it is possible that data for the management group is accumulated and stored in the management image history storage computer (A)2a, data for the ordinary employee group is accumulated and stored in the ordinary employee image history storage computer (B)2b, and data for the temporary employee group is accumulated and stored in the temporary employee image history storage computer (C)2c (see FIG. 20(c)).

(Image Forming Class Information)

As shown in FIG. 17, the image history storage computers 2 include a plurality of image forming class image history storage computers whose image forming classes differ from each other (for example, a copy image history storage computer (A)2a, a facsimile image history storage computer (B)2b, and a print image history storage computer (C)2c). Also, as shown in FIG. 21(a), the attribute information includes image forming class information (for example, copy, facsimile, and print class information) for the image forming apparatus 1, and as shown in FIG. 21(b), the collected information includes image forming class information (for example, copy, facsimile, and print class information) for the image forming apparatus 1 corresponding respectively to the plurality of image forming class image history storage computers (A)2a, (B)2b, and (C)2c.

As shown in FIG. 19, in Step S205 of filtering attribute information, when the image forming class information in the attribute information (see FIG. 21(a)) matches image forming class information in the corresponding filtering information (see FIG. 21(b)), the image forming class image history storage computers (A)2a, (B)2b, and (C)2c (computer (C)2c not shown in FIG. 19) that request attribute information request sending of image data corresponding to the attribute information.

For example, in Step S205 of filtering attribute information, when the image forming class information in the attribute information is copy class information in the filtering information, the copy image history storage computer (A)2a that requests attribute information requests sending of image data corresponding to the attribute information. Also, when the image forming class information in the attribute information is facsimile class information in the filtering information, the facsimile image history storage computer (B)2b that requests attribute information requests sending of image data corresponding to the attribute information. Furthermore, when the image forming class information in the attribute information is print class information in the filtering information, the print image history storage computer (C)2c that requests attribute information requests sending of image data corresponding to the attribute information. Thus, it is possible that copy image data is accumulated and stored in the copy image history storage computer (A)2a, facsimile image data is accumulated and stored in the facsimile image history storage computer (B)2b, and print image data is accumulated and stored in the print image history storage computer (C)2c (see FIG. 21(c)).

(Image Data Image Format Information)

As shown in FIG. 18, the image history storage computers 2 include a plurality of image format image history storage computers whose image data image formats differ from each other (for example, a TIFF image history storage computer (A)2a and a PDF image history storage computer (B)2b). Also, as shown in FIG. 22(a), the attribute information includes image data image format information (for example, TIFF and PDF image data image format information), and as shown in FIG. 22(b), the collected information includes image data image format information (for example, TIFF and PDF image data image format information) corresponding respectively to the plurality of image format image history storage computers (A)2a and (B)2b.

As shown in FIG. 19, in Step S205 of filtering attribute information, when the image format information in the attribute information (see FIG. 22(a)) matches image format information in the corresponding filtering information (see FIG. 22(b)), the image format image history storage computers (A)2a and (B)2b that request attribute information request sending of image data corresponding to the attribute information.

For example, in Step S205 of filtering attribute information, when the image data image format information in the attribute information is TIFF image format information in the filtering information, the TIFF image history storage computer (A)2a that requests attribute information requests sending of image data corresponding to the attribute information. Also, when the image data image format information in the attribute information is PDF image format information in the filtering information, the PDF image history storage computer (B)2b that requests attribute information requests sending of image data corresponding to the attribute information. Thus, it is possible that TIFF image data is accumulated and stored in the TIFF image history storage computer (A)2a, and PDF image data is accumulated and stored in the PDF image history storage computer (B)2b (see FIG. 22(c)).

(Image Data Text Presence or Absence Information)

As shown in FIG. 18, the image history storage computers 2 include a text-attached image history storage computer (A)2a and a no-text image history storage computer (B)2b. Also, as shown in FIG. 23(a), the attribute information includes text presence or absence information of image data with text attached and without text attached, and as shown in FIG. 23(b), the collected information includes text presence or absence information of image data with text attached and without text attached corresponding respectively to the text-attached image history storage computer (A)2a and the no-text image history storage computer (B)2b.

Here, a text-attached image includes text data obtained by, in the image forming apparatus 1, extracting a text image portion from image data, performing optical character recognition processing on this text image portion, and converting this text image portion into character codes.

As shown in FIG. 19, in Step S205 of filtering attribute information, when the text presence or absence information in the attribute information (see FIG. 23(a)) is text-attached image information in the corresponding filtering information (see FIG. 23(b)), the text-attached image history storage computer (A)2a that requests attribute information requests sending of image data corresponding to the attribute information. When the text presence or absence information in the attribute information (see FIG. 23(a)) is no-text image information in the corresponding filtering information (see FIG. 23(b)), the no-text image history storage computer (B)2b that requests attribute information requests sending of image data corresponding to the attribute information. Thus, it is possible that image data of an image with text attached is accumulated and stored in the text-attached image history storage computer (A)2a, and image data of an image without text attached is accumulated and stored in the no-text image history storage computer (B)2b (see FIG. 23(c)). By, in this manner, storing image data in image history storage computers divided into image data with text attached and image data without text attached, it is possible to easily realize text searching of image data with text attached.

(Image Data Restriction Level Information)

As shown in FIG. 17, the image history storage computers 2 include a plurality of restriction image history storage computers whose image data restriction levels differ from each other (for example, a high restriction level image history storage computer (A)2a, a medium restriction level image history storage computer (B)2b, and a low restriction level image history storage computer (C)2c). Also, as shown in FIG. 24(a), the attribute information includes image data restriction level information (for example, high level, medium level, and low level restriction level information), and as shown in FIG. 24(b), the collected information includes image data restriction level information (for example, high level, medium level, and low level restriction level information) corresponding respectively to the plurality of restriction level image history storage computers (A)2a, (B)2b, and (C)2c.

As shown in FIG. 19, in Step S205 of filtering attribute information, when the image data restriction level information in the attribute information (see FIG. 24(a)) matches image data restriction level information in the corresponding filtering information (see FIG. 24(b)), the restriction image history storage computers (A)2a, (B)2b, and (C)2c (computer (C)2c not shown in FIG. 19) that request attribute information request sending of image data corresponding to the attribute information. Thus, it is possible that, for example, image data with a high restriction level is accumulated and stored in the high restriction level image history storage computer (A)2a, image data with a medium restriction level is accumulated and stored in the medium restriction level image history storage computer (B)2b, and image data with a low restriction level is accumulated and stored in the low restriction level image history storage computer (C)2c (see FIG. 24(c)). By, in this manner, storing image data with a high level of secrecy only in a high restriction level (high security level) image history storage computer, it is possible to effectively prevent divulging the image data.

Note that the image history storage system in the first embodiment may include a maintenance tool as shown in FIG. 14.

That is, a configuration may be adopted in which, in at least one image history storage computer 2 (one image history storage computer 2b in the example in FIG. 14), according to an image history storage program, a step of displaying filtering information (Step S301), a step of editing filtering information (Step S302), and a step of updating filtering information, in which filtering information in all of the image history storage computers 2 other than an image history storage computer in which filtering information has been edited is updated via the network 4 to the updated filtering information (Step S303), are additionally executed. By adopting such a configuration, it is possible to easily make additions or modifications to the filtering information, and it is also possible to omit the labor of an updating operation that updates the filtering information for each image history storage computer 2.

Further, in the first embodiment, a configuration may be adopted in which, in at least one image history storage computer 2, a step of displaying identification information for the image forming apparatuses 1, a step of editing identification information, and a step of updating identification information, in which identification information in all of the image history storage computers other than an image history storage computer in which identification information has been edited is updated via the network 4 to the updated identification information, are additionally executed. By adopting such a configuration, it is possible to easily make additions or modifications to the identification information, and it is also possible to omit the labor of an updating operation that updates the identification information for each image history storage computer 2.

<Basic Configuration of Image History Storage System of Second Embodiment>

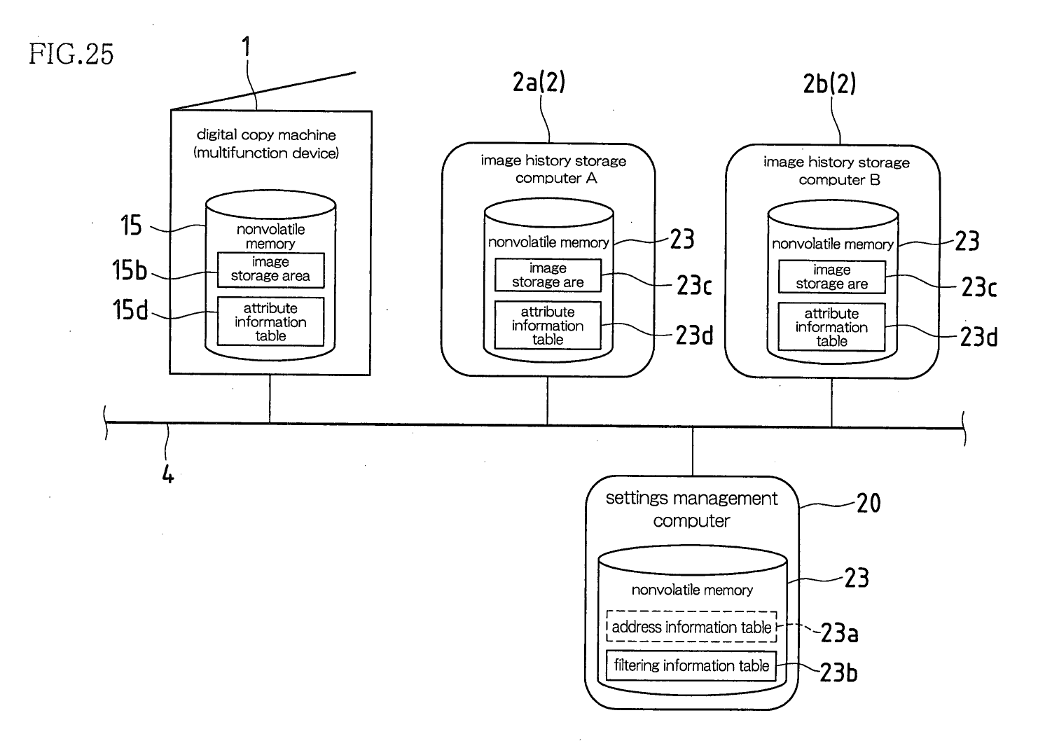

FIG. 25 is a block diagram that shows an example of the basic configuration of an image history storage system of a second embodiment that implements an image history storage method according to the present invention.

The image history storage system shown in FIG. 25 accumulates and stores image data that has been processed with image forming apparatuses 1 to at least two image history storage computers among a plurality of computers connected via a network 4 to one or a plurality of image forming apparatuses (here, a plurality of image forming apparatuses 1).

Specifically, in this image history storage system, image forming apparatuses 1, image history storage computers 2, one settings management computer 20, and personal computers 3 (not shown) are interconnected via a network 4, and thus a communications connection for data communications or the like between the image forming apparatuses 1 and the personal computers 3, or between the image forming apparatuses 1 and the image history storage computers 2, is possible.

In the image history storage system of the second embodiment shown in FIG. 25, according to an image history storage program, a step of storing filtering information is executed in the one settings management computer 20, and a step of reading out filtering information is executed in the image history storage computers 2. Other aspects of the configuration are substantially the same as in the image history storage system of the first embodiment, and therefore are assigned the same reference numerals and not described in detail here.

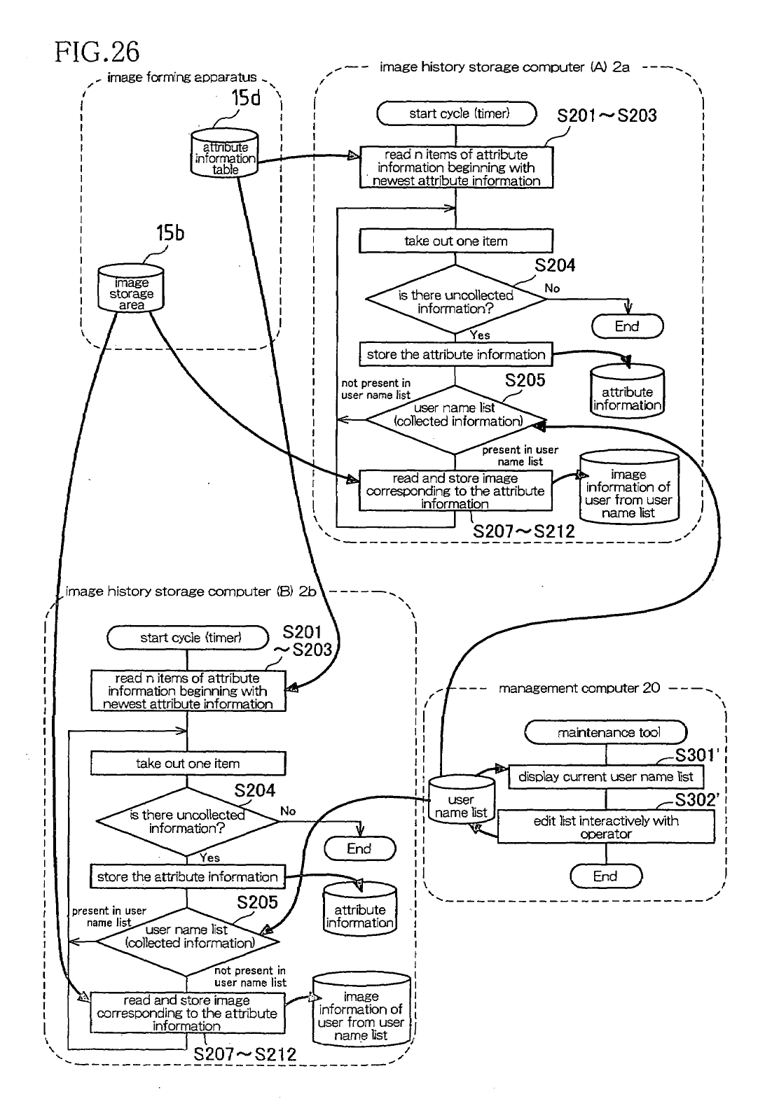

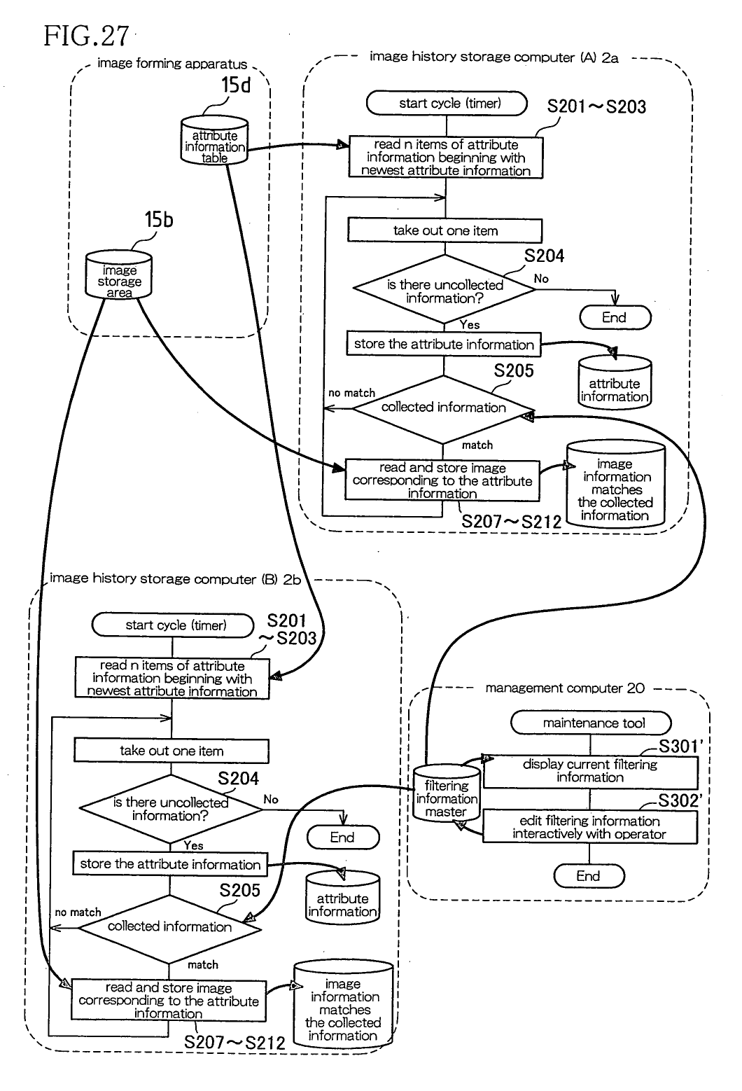

FIG. 26 is a flowchart that shows an example process of the image history storage system according to the second embodiment. FIG. 27 is a flowchart that shows another example process of the image history storage system according to the second embodiment.

The flowcharts shown in FIGS. 26 and 27 respectively show examples in which, in the flowcharts shown in FIGS. 14 and 19, instead of executing the step of storing filtering information in the image history storage computers 2, the step of storing filtering information is executed in the one settings management computer 20, and the step of reading out filtering information is executed in the image history storage computers 2. Accordingly, the same step numbers are assigned to substantially the same step locations, and the description below focuses on the step of storing filtering information and the step of reading out filtering information.

As shown in FIGS. 26 and 27, in the step of storing filtering information, in the one settings management computer 20, filtering information is stored and maintained in the filtering information table 23b of the nonvolatile memory 23 by a human operation performed by a user from an unshown operating portion. In the step of reading out filtering information, in each image history storage computer 2, the filtering information that is stored and maintained in the nonvolatile memory 23 of the one settings management computer 20 is read out from the one settings management computer 20 via the network 4.

In Step S205 of filtering attribute information, the filtering information that has been read out from the one settings management computer 20 is used as filtering information.

Thus, it is possible to store and maintain the filtering information in the one settings management computer 20. Accordingly, it is possible to omit the labor of a registration operation that registers filtering information for each image history storage computer 2.

The image history storage computers 2 further include a maintenance tool as shown in FIG. 26 and 27.

That is, the one settings management computer 20, according to an image history storage program, further executes a step of displaying filtering information (Step S301′), and a step of editing filtering information (Step S302′). Thus, it is possible to easily make additions or modifications to the filtering information.

Note that in the image history storage system according to the second embodiment, a configuration may be adopted in which a step of storing identification information is executed in the one settings management computer 20, and a step of reading out identification information is executed in the image history storage computers 2.

That is, in the step of storing identification information, in the one settings management computer 20, identification information for the image forming apparatuses 1 may be stored and maintained in the address information table 23a of the nonvolatile memory 23 (see dotted line in FIG. 25). Also, in the step of reading out identification information, in each image history storage computer 2, the identification information for the image forming apparatuses 1 that is stored and maintained in the nonvolatile memory 23 of the one settings management computer 20 may be read out from the one settings management computer 20 via the network 4. In this case, in Step S202 of requesting identification information, it is possible to use the identification information read out from the one settings management computer 20 as identification information. Thus, it is possible to store and maintain the identification information in the one settings management computer 20. Accordingly, it is possible to omit the labor of a registration operation that registers identification information for each image history storage computer 2.

Also, in the image history storage system according to the second embodiment, a configuration may be adopted in which in the one settings management computer 20, according to an image history storage program, a step of displaying identification information for the image forming apparatuses 1, and a step of editing identification information for the image forming apparatuses 1, are executed. Thus, it is possible to easily make additions or modifications to the identification information.

Also, in the image history storage system according to the second embodiment, a configuration may be adopted in which one of the image history storage computers 2 serves also as the one settings management computer 20. Thus, it is possible to reduce the cost of providing a settings management computer separate from the image history storage computers 2.

The present invention may be embodied in various other forms without departing from the gist or essential characteristics thereof The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image history storage method that accumulates and stores image data to at least two image history storage computers among a plurality of computers connected via a network to one or a plurality of image forming apparatuses that accumulate the image data and attribute information related to that image data, the method comprising:
a step of requesting identification information in which, using identification information for the one or the plurality of image forming apparatuses that exist on the network, the at least two image history storage computers access an image forming apparatus corresponding to the identification information via the network, and request the attribute information accumulated in the image forming apparatus from the image forming apparatus;
a step of sending attribute information in which the attribute information accumulated in the image forming apparatus that responded to the request of the image history storage computer that requests the attribute information is sent from the image forming apparatus via the network to the image history storage computer;
a step of filtering attribute information in which, using filtering information that exists on the network, which is filtering information for judging whether or not to request sending of the image data, in the image history storage computer that requests the attribute information, based on the attribute information from the image forming apparatus that responded to the request of the image history storage computer, and the filtering information, a judgment is performed of whether or not to make a request to the image forming apparatus to send image data corresponding to the attribute information;
a step of requesting image data in which, when judged in the image history storage computer that requests the attribute information that it is necessary to request sending of image data corresponding to the attribute information from the image forming apparatus that responded to the request of the image history storage computer, the image history storage computer that judged that the sending request is necessary requests to the image forming apparatus, via the network, for image data corresponding to target attribute information that is the target for which the sending request was judged necessary among the attribute information accumulated in the image forming apparatus that responded to the request of the image history storage computer;
a step of sending image data in which, from the image forming apparatus that responded to the request of the image history storage computer that requests image data corresponding to the target attribute information, image data that is accumulated in the image forming apparatus and corresponds to the target attribute information is sent to the image history storage computer via the network; and
a step of accumulating and storing image data in which, in the image history storage computer that requests image data corresponding to the target attribute information, image data corresponding to the target attribute information from the image forming apparatus that responded to the request of the image history storage computer is received, and accumulated and stored.

2. The image history storage method according to claim 1, further comprising:
a step of storing filtering information in which, in each of the at least two image history storage computers, the filtering information is stored and maintained;
wherein in the step of filtering attribute information, filtering information that is stored and maintained in the image history storage computer that requests the attribute information is used as the filtering information.

3. The image history storage method according to claim 2, further comprising:
a step of editing filtering information in which, in at least one of the at least two image history storage computers, the filtering information is edited; and
a step of updating filtering information in which filtering information in all of the image history storage computers other than an image history storage computer in which the filtering information has been edited is updated via the network to the edited filtering information.

4. The image history storage method according to claim 1, further comprising:
a step of storing filtering information in which, in a single settings management computer among the plurality of computers, the filtering information is stored and maintained; and
a step of reading out filtering information in which, in each of the at least two image history storage computers, the filtering information stored and maintained in the single settings management computer is read out from the single settings management computer via the network;
wherein in the step of filtering attribute information, filtering information that has been read out from the single settings management computer is used as the filtering information.

5. The image history storage method according to claim 4, further comprising:
a step of editing filtering information in which, in the single settings management computer, the filtering information is edited.

6. The image history storage method according to claim 4, wherein one among the at least two image history storage computers serves also as the single settings management computer.

7. The image history storage method according to claim 1, further comprising:
a step of storing identification information in which, in each of the at least two image history storage computers, identification information for the one or the plurality of image forming apparatuses is stored and maintained;
wherein in the step of requesting identification information, identification information that is stored and maintained in the image history storage computer that requests the attribute information is used as the identification information.

8. The image history storage method according to claim 7, further comprising:
a step of editing identification information in which, in at least one of the at least two image history storage computers, the identification information for the one or the plurality of image forming apparatuses is edited; and
a step of updating identification information in which identification information in all of the image history storage computers other than an image history storage computer in which the identification information has been edited is updated via the network to the edited identification information.

9. The image history storage method according to claim 4, further comprising:
a step of storing identification information in which, in the single settings management computer, the identification information for the one or the plurality of image forming apparatuses is stored and maintained; and
a step of reading out identification information in which, in each of the at least two image history storage computers, the identification information for the one or the plurality of image forming apparatuses that is stored and maintained in the single settings management computer is read out from the single settings management computer via the network;
wherein in the step of requesting identification information, identification information that has been read out from the single settings management computer is used as the identification information.

10. The image history storage method according to claim 9, further comprising:
a step of editing identification information in which, in the single settings management computer, the identification information for the one or the plurality of image forming apparatuses is edited.

11. The image history storage method according to claim 1, wherein:
the at least two image history storage computers include one collected information image history storage computer and another other collected information image history storage computer;
the filtering information includes a predetermined type of collected information; and
in the step of filtering attribute information, when judged that the attribute information is collected information in the filtering information, the collected information image history storage computer that requests the attribute information requests sending of image data corresponding to the attribute information, and when judged that the attribute information is not collected information in the filtering information, the other collected information image history storage computer that requests the attribute information requests sending of image data corresponding to the attribute information.

12. The image history storage method according to claim 11, wherein:
the at least two image history storage computers include one user image history storage computer and another other user image history storage computer;
the attribute information includes user information for the image data;
the collected information includes a user information list made up of the user information; and
in the step of filtering attribute information, when user information in the attribute information exists in the user information list in the filtering information, the user image history storage computer that requests the attribute information requests sending of image data corresponding to the attribute information, and when user information in the attribute information does not exist in the user information list in the filtering information, the other user image history storage computer that requests the attribute information requests sending of image data corresponding to the attribute information.

13. The image history storage method according to claim 1, wherein:
the at least two image history storage computers include a plurality of collected information image history storage computers whose collected information differs from each other;
the filtering information includes a predetermined plurality of types of collected information that respectively correspond to the plurality of collected information image history storage computers; and
in the step of filtering attribute information, when judged that the attribute information matches collected information in the filtering information corresponding to the collected information image history storage computer, the collected information image history storage computer that requests the attribute information requests sending of image data corresponding to the attribute information.

14. The image history storage method according to claim 13, wherein:
the at least two image history storage computers include a plurality of user group image history storage computers whose user information groups differ from each other;
the attribute information includes user group information for the image data;
the filtering information includes a group information list made up of user group information that respectively corresponds to the plurality of user group image history storage computers; and
in the step of filtering attribute information, when user group information in the attribute information matches user group information of the group information list in the filtering information corresponding to the user group image history storage computer, the user group image history storage computer that requests the attribute information requests sending of image data corresponding to the attribute information.

15. The image history storage method according to claim 13, wherein:
the at least two image history storage computers include a plurality of image forming class image history storage computers whose image forming classes of the image forming apparatus differ from each other;
the attribute information includes image forming class information for the image forming apparatus;
the filtering information includes image forming class information for the image forming apparatus that respectively corresponds to the plurality of image forming class image history storage computers; and
in the step of filtering attribute information, when image forming class information in the attribute information matches image forming class information in the filtering information corresponding to the image forming class image history storage computer, the image forming class image history storage computer that requests the attribute information requests sending of image data corresponding to the attribute information.

16. The image history storage method according to claim 15, wherein:
the at least two image history storage computers include one copy image history storage computer, another facsimile image history storage computer, and another print image history storage computer;
the attribute information includes copy, facsimile, and print class information;
the filtering information includes copy, facsimile, and print class information that respectively corresponds to the copy image history storage computer, the facsimile image history storage computer, and the print image history storage computer; and
in the step of filtering attribute information, when image forming class information in the attribute information is copy class information in the corresponding filtering information, the copy image history storage computer that requests the attribute information requests sending of image data corresponding to the attribute information, and when image forming class information in the attribute information is facsimile class information in the corresponding filtering information, the facsimile image history storage computer that requests the attribute information requests sending of image data corresponding to the attribute information, and when image forming class information in the attribute information is print class information in the corresponding filtering information, the print image history storage computer that requests the attribute information requests sending of image data corresponding to the attribute information.

17. The image history storage method according to claim 13, wherein:
the at least two image history storage computers include a plurality of image format image history storage computers whose image formats for the image data differ from each other;
the attribute information includes image format information for the image data;
the filtering information includes image format information for the image data that respectively corresponds to the plurality of image format image history storage computers; and
in the step of filtering attribute information, when image format information in the attribute information matches image format information in the filtering information corresponding to the image format image history storage computer, the image format image history storage computer that requests the attribute information requests sending of image data corresponding to the attribute information.

18. The image history storage method according to claim 17, wherein:
the at least two image history storage computers include one TIFF image history storage computer and another PDF user image history storage computer;
the attribute information includes TIFF and PDF image format information for the image data;
the filtering information includes TIFF and PDF image format information for the image data that respectively corresponds to the TIFF image history storage computer and the PDF image history storage computer; and
in the step of filtering attribute information, when the image format information for the image data in the attribute information is TIFF image format information in the corresponding filtering information, the TIFF image history storage computer that requests the attribute information requests sending of image data corresponding to the attribute information, and when the image format information for the image data in the attribute information is PDF image format information in the corresponding filtering information, the PDF image history storage computer that requests the attribute information requests sending of image data corresponding to the attribute information.

19. The image history storage method according to claim 13, wherein:
the at least two image history storage computers include one text-attached image history storage computer and another no-text image history storage computer;
the attribute information includes text presence or absence information of text-attached image and no-text image for the image data;
the filtering information includes the text presence or absence information of text-attached image and no-text image for the image data that respectively corresponds to the text-attached image history storage computer and the no-text image history storage computer; and
in the step of filtering attribute information, when the text presence or absence information in the attribute information is text-attached image information in the corresponding filtering information, the text-attached image history storage computer that requests the attribute information requests sending of image data corresponding to the attribute information, and when the text presence or absence information in the attribute information is no-text image information in the corresponding filtering information, the no-text image history storage computer that requests the attribute information requests sending of image data corresponding to the attribute information.

20. The image history storage method according to claim 13, wherein:
the at least two image history storage computers include a plurality of restriction image history storage computers whose restriction levels for the image data differ from each other;
the attribute information includes restriction level information for the image data;
the filtering information includes restriction level information for the image data that respectively corresponds to the plurality of restriction image history storage computers; and
in the step of filtering attribute information, when restriction level information for the image data in the attribute information matches restriction level information for the image data in the filtering information corresponding to the restriction image history storage computer, the restriction image history storage computer that requests the attribute information requests sending of image data corresponding to the attribute information.

21. The image history storage method according to claim 1, further comprising:
a step of requesting image data deletion in which, after accumulating and storing image data corresponding to the target attribute information in the step of accumulating and storing image data, the image history storage computer that requests image data corresponding to the target attribute information requests, to the image forming apparatus that responded to the request of the image history storage computer, via the network, to delete the image data; and
a step of deleting image data in which it is deleted the image data corresponding to the target attribute information that is accumulated in the image forming apparatus that responded to the request of the image history storage computer from the image history storage computer that requests deletion of the image data.

22. The image history storage method according to claim 1, further comprising:
a step of accumulating and storing attribute information in which, in the image history storage computer that requests the attribute information, it is accumulated and stored the attribute information that has been sent from the image forming apparatus that responded to the request in the step of sending attribute information.

23. The image history storage method according to claim 22, further comprising:
a step of requesting attribute information deletion in which, after accumulating and storing image data corresponding to the target attribute information in the step of accumulating and storing image data, the image history storage computer that requests image data corresponding to the target attribute information requests, to the image forming apparatus that responded to the request of the image history storage computer, via the network, to delete the target attribute information; and
a step of deleting attribute information in which the target attribute information that is accumulated in the image forming apparatus that responded to the request of the image history storage computer is deleted from the image history storage computer that requests deletion of target attribute information.

24. The image history storage method according to claim 1, wherein in the step of requesting identification information, the attribute information that is accumulated in the image forming apparatus corresponding to the identification information is requested from the image forming apparatus according to a time schedule, other than when network communications are concentrated.

25. An image history storage system that accumulates and stores image data to at least two image history storage computers among a plurality of computers connected via a network to one or a plurality of image forming apparatuses that accumulate the image data and attribute information related to that image data, wherein:
each of the at least two image history storage computers, using identification information for the one or the plurality of image forming apparatuses that exist on the network, accesses an image forming apparatus corresponding to the identification information via the network, and requests the attribute information accumulated in the image forming apparatus from the image forming apparatus;
the attribute information accumulated in the image forming apparatus that responded to the request is sent from the image forming apparatus via the network to the image history storage computer;
using filtering information that exists on the network, which is filtering information for judging whether or not to request sending of the image data, based on the attribute information from the image forming apparatus that responded to the request, and the filtering information, a judgment is performed of whether or not to make a request to the image forming apparatus to send image data corresponding to the attribute information;
when judged that it is necessary to request sending of image data corresponding to the attribute information from the image forming apparatus that responded to the request, via the network, image data is requested from the image forming apparatus corresponding to target attribute information that is the target for which the sending request was judged necessary among the attribute information accumulated in the image forming apparatus that responded to the request;
image data that is accumulated in the image forming apparatus and corresponds to the target attribute information is sent from the image forming apparatus that responded to the request to the image history storage computer via the network; and
the image data corresponding to the target attribute information from the image forming apparatus that responded to the request is received, and accumulated and stored.

26. An image history storage program for allowing a computer to execute each step of the image history storage method according to any one of claims 1 to 5.

27. A computer-readable recording medium on which an image history storage program according to claim 26 is recorded.
